(19) United States
(12) Patent Application Publication
(10) Pub. No.: US 2024/0272192 A1
(43) Pub. Date: Aug. 15, 2024

(54) DISPENSING DEVICE AND DISPENSING METHOD

(71) Applicant: SHIMADZU CORPORATION, Kyoto-shi (JP)

(72) Inventors: Akihito KORENAGA, Kyoto-shi (JP); Hiroyuki YAMASHITA, Kyoto-shi (JP)

(21) Appl. No.: 18/438,239

(22) Filed: Feb. 9, 2024

(30) Foreign Application Priority Data
Feb. 15, 2023 (JP) 2023-021984
Sep. 20, 2023 (JP) 2023-153999

(51) Int. Cl. G01N 35/10

(52) U.S. Cl. CPC G01N 35/1074; G01N 35/1011

(57) ABSTRACT

A dispensing device capable of aspirating or dispensing a liquid from or into each of a plurality of wells provided on a container, the plurality of wells being aligned linearly, includes: a support portion configured to support the container; a dispensing head having a plurality of tip attachments aligned linearly, the dispensing head being configured to aspirate and dispense a liquid from or into dispensing tips attached to the tip attachments; and a first drive unit configured to rotate at least one of the dispensing head and the support portion relative to the other so that an alignment direction of the plurality of tip attachments coincides with an alignment direction of the plurality of wells.

### CROSS-REFERENCE TO RELATED APPLICATIONS

This application claims priority under 35 U.S.C. § 119 to Japanese Patent Application No. 2023-021984, filed on Feb. 15, 2023, and Japanese Patent Application No. 2023-153999, filed on Sep. 20, 2023, the entire disclosure of which is incorporated herein by reference in its entirety.

### BACKGROUND OF THE INVENTION

### Field of the Invention

The present disclosure relates to a dispensing device and a dispensing method.

### Description of the Related Art

The following description sets forth the inventor's knowledge of the related art and problems therein and should not be construed as an admission of knowledge in the prior art.

In a test and an analysis performed in the field of biochemistry and other fields, a dispensing device is used to dispense a liquid specimen into a plurality of wells of a container, such as a well plate and a microplate. A recent dispensing device has a configuration capable of dispensing a liquid into a number of wells in a container at the same time.

The liquid dispensing device described in Japanese Patent No. 4235599 has a dispensing head device with a nozzle unit. The nozzle unit is equipped with a plurality of nozzles having the same array pattern so that a plurality of tips is arranged in a grid pattern. The tip is a tapered nozzle-like part with a through-hole through which a liquid can be aspirated or dispensed.

In general, a container used for a dispensing device is standardized in the arrangement of a plurality of wells. For example, a microplate with 96 (8×12) wells or a microplate with 384 (16×24) wells is used.

The dispensing device described in Japanese Patent No. 4235599 is configured such that one type of nozzle unit can be replaced with another type of nozzle unit.

In the liquid dispensing device described in Japanese Patent No. 4235599, a plurality of microplates with different specifications can be used by replacing the nozzle unit.

However, in the liquid dispensing device described in Japanese Patent No. 4235599, it is necessary to prepare a plurality of nozzle units corresponding to various types of microplates. This increases the cost of the liquid dispensing device. Specifically, in the case where the longitudinal alignment direction of the plurality of wells of the microplate to be supported on the stage is different from the longitudinal alignment direction of the plurality of nozzles in the nozzle unit, the nozzle unit needs to be replaced.

In the case where the arrangement direction of the plurality of wells in one microplate supported on a stage is different from the arrangement direction of the plurality of wells in the other microplate supported on the stage, it is difficult or impossible to aspirate a liquid from one microplate and dispense the aspirated liquid into the other microplate.

### SUMMARY OF THE INVENTION

The present disclosure has been made to solve the above-described problems. The purpose of the present disclosure is to provide a dispensing device and a dispensing method capable of aspirating and dispensing a liquid with a simple configuration and a simple dispense operation for various types of containers different in the alignment direction of a plurality of wells while suppressing the cost increase.

(1) A first aspect of the present disclosure relates to a dispensing device capable of aspirating or dispensing a liquid from or into each well of a plurality of wells provided on a container, the plurality of wells being aligned linearly.

The dispensing device includes:
a support portion configured to support the container;
a dispensing head having a plurality of tip attachments aligned linearly, the dispensing head being configured to aspirate and dispense a liquid from or into dispensing tips attached to the tip attachments; and
a first drive unit configured to rotate at least one of the dispensing head and the support portion relative to the other so that an alignment direction of the plurality of tip attachments coincides with an alignment direction of the plurality of wells.

(2) A second aspect of the present disclosure relates to a dispensing method of performing dispensing using a dispensing head having a plurality of tip attachments aligned linearly.

The method includes:
a step of supporting a container by a support portion, the container having a plurality of wells aligned linearly;
a step of rotating at least one of the dispensing head and the support portion relative to the other so that an alignment direction of the plurality of tip attachments coincides with an alignment direction of the plurality of wells; and
a step of aspirating a liquid from the plurality of wells of the container into dispensing tips attached to the plurality of respective tip attachments or dispensing the liquid from the dispensing tips attached to the plurality of respective tip attachments into the plurality of wells of the container, in a state in which the alignment direction of the plurality of tip attachments coincides with the alignment direction of the plurality of wells.

According to the present disclosure, it is possible to provide a dispensing device and a dispensing method capable of aspirating and dispensing a liquid with a simple configuration and a simple dispense operation for various types of containers different in the alignment direction of a plurality of wells while suppressing the cost increase.

Other features, elements, characteristics, and advantages of the present disclosure will become more apparent from the following description of preferred embodiments of the present disclosure with reference to the attached drawings.

### BRIEF DESCRIPTION OF THE DRAWINGS

The preferred embodiments of the present disclosure are shown by way of example, and not limitation, in the accompanying figures.

FIG. 1 is a schematic diagram describing the configuration of a dispensing device according to one embodiment.

FIG. 2 is a schematic plan view describing a first well plate and a second well plate.

FIG. 3 is a schematic plan view describing a first well plate and a second well plate.

FIG. 4 is a schematic plan view describing a first well plate and a second well plate.

FIG. 5 is a schematic plan view showing a state on first and second well plates by the control of a controller.

FIG. 6 is a schematic plan view showing a state on first and second well plates by the control of a controller.

FIG. 7 is a schematic plan view showing a state on first and second well plates by the control of a controller.

FIG. 8 is a schematic plan view showing a state on first and second well plates by the control of a controller.

FIG. 9 is a schematic plan view showing a state on first and second well plates by the control of a controller.

FIG. 10 is a schematic plan view showing a state on first and second well plates by the control of a controller.

FIG. 11 is a schematic plan view showing a state on first and second well plates by the control of a controller.

FIG. 12 is a diagram describing the configuration of a posture change device used in a modification.

FIG. 13 is a diagram describing the configuration of a posture change device used in a modification.

FIG. 14 is a diagram describing the configuration of a posture change device used in a modification.

FIG. 15 is a diagram describing the configuration of a posture change device used in a modification.

FIG. 16 is a diagram describing the configuration of a posture change device used in a modification.

FIG. 17 is a diagram describing the configuration of a posture change device used in a modification.

FIG. 18 is a diagram describing the operation of a posture change device used in a modification.

FIG. 19 is a diagram describing the operation of a posture change device used in a modification.

FIG. 20 is a diagram describing the operation of a posture change device used in a modification.

FIG. 21 is a diagram describing the operation of a posture change device used in a modification.

FIG. 22 is a diagram describing the operation of a posture change device used in a modification.

FIG. 23 is a diagram describing the operation of a posture change device used in a modification.

### DETAILED DESCRIPTION OF THE PREFERRED EMBODIMENTS

Hereinafter, some embodiments of a dispensing device and a dispensing method according to the present disclosure will be described with reference to the attached drawings.

### (1) Dispensing Device

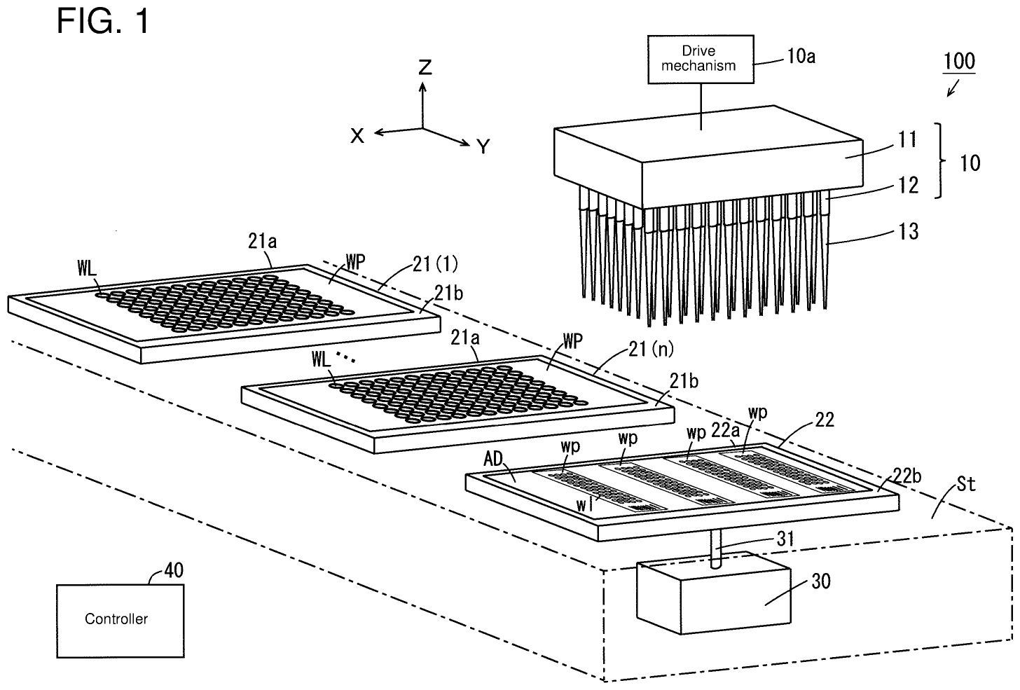

FIG. 1 is a schematic diagram describing the configuration of a dispensing device according to one embodiment. FIG. 1 is labeled with arrows indicating the X-direction, the Y-direction, and the Z-direction, which are mutually orthogonal to each other to clarify the positional relation. The X-direction and the Y-direction are orthogonal to each other within the horizontal plane, and the Z-direction corresponds to the vertical direction. In this embodiment, the X-direction corresponds to a first direction, and the Y-direction corresponds to a second direction.

The dispensing device 100 is provided with a dispensing head 10, a plurality of first support portions 21, a second support portion 22, a rotary drive unit 30, and a controller 40. The dispensing head 10 includes an aspiration-dispensation mechanism 11, a plurality of tip attachments 12, and a drive mechanism 10a.

The plurality of tip attachments 12 is provided on the bottom surface of the aspiration-dispensation mechanism 11. Each tip attachment 12 is, for example, a nozzle. A dispensing tip 13 is attached to each tip attachment 12 so as to face downward. The dispensing device 100, according to this embodiment, is configured such that a dispensing tip 13 can be attached to a desired tip attachment 12.

In the example shown in FIG. 1, the dispensing tips 13 are attached to all of the tip attachments 12. The plurality of tip attachments 12 is arranged in a matrix of a plurality of rows and a plurality of columns in the horizontal plane. Each column and each row are orthogonal to each other. Each row has a plurality of tip attachments 12 arranged in a straight line at equal intervals. Each column has a plurality of tip attachments 12 arranged in a straight line at equal intervals. The number of the plurality of tip attachments 12 in each row is greater than the number of the plurality of tip attachments 12 in each column. Thus, the direction of each row is a longitudinal direction, and the direction of each column is a transverse direction. Hereinafter, the longitudinal direction of the dispensing head 10 will be referred to as the alignment direction of the plurality of tip attachments 12.

The aspiration-dispensation mechanism 11 includes, for example, a plurality of syringes corresponding to the plurality of tip attachments 12, which enables aspiration of a liquid into the dispensing tip 13 attached to the tip attachment 12 and dispense of the liquid from the dispensing tip 13. Hereinafter, the aspirating of a liquid by the dispensing head 10 into the dispensing tip 13 and the dispensing of the liquid from the dispensing tip 13 are collectively referred to as a dispensing operation. The dispensing head 10 is supported in a movable manner by the drive mechanism 10a in the X-direction, the Y-direction, and the Z-direction. This configuration allows the dispensing head 10 to move three-dimensionally. The dispensing head 10 is used for dispensing operations for a plurality of first well plates WP and a plurality of second well plates wp, as will be described below. The first well plates WP and the second well plate wp each have a rectangular shape.

The plurality of first support portions 21 and the second support portion 22 are arranged in the Y-direction on the stage St. The plurality of first support portions 21 is each fixed to the stage St with each long side parallel to the X-direction and each short side parallel to the Y-direction, and the second support portion 22 is provided on the stage St in a rotatable manner. In the standard state, each long side of the second support portion 22 is parallel to the X-direction, and each short side thereof is parallel to the Y-direction. In this embodiment, “n” pieces of the first support portions 21 are used. “n” is a positive integer. Note that in FIG. 1, the second to (n−1)^{th} first support portions 21 are omitted from the illustration. The plurality of the first support portions 21 and the second support portion 22 each have a support surface 21a and 22a. On the support surface 21a, 22a, a rectangular outer frame portion 21b, 22b along the outer edge of the first well plate WP is formed.

The outer frame portion 21b of each first support portion 21 is configured to have a size capable of fitting a first well plate WP therein. The first well plate WP is fitted in the outer frame portion 21b of each first support portion 21. In this case, the long side of each first well plate WP is parallel to the X-direction, and the short side thereof is parallel to the Y-direction. A plurality of second well plates wp is fixed in the outer frame portion 22b of the second support portion 22 by means of an adapter AD.

The adapter AD is rectangular in shape and is configured to fix the plurality of second well plates wp on its top surface. The first well plate WP has a plurality of wells WL. Each of the second well plates wp has a plurality of wells wl. In this embodiment, four pieces of second well plates wp are fixed in the outer frame portion 22b of the second support portion 22. In this case, the plurality of the second well plates wp is arranged in the X-direction. The long side of each second well plate wp is parallel to the Y-direction, and the short side thereof is parallel to the X-direction.

In this embodiment, the first well plate WP and the second well plate wp conform to different standards. Therefore, the size of each first well plate WP (length of the long side and that of the short side) is different from the size of each second well plate wp (length of the long side and that of the short side). Further, the number of wells WL in each first well plate WP is different from the number of wells wl in the second well plate wp. Further, the arrangement of wells WL in the first well plate WP is different from the arrangement of wells wl in the second well plate wp.

Below the support portion 22, the rotary drive unit 30 is accommodated in the stage St. The bottom surface of the support portion 22 is connected to the rotary drive unit 30 via a connection member 31 extending in the Z-direction. The rotary drive unit 30 includes, for example, an electric motor (not illustrated) to rotate the support portion 22 about an axis of the Z-direction via the connection member 31. The controller 40 includes a CPU (central processing unit), a RAM (random access memory), a ROM (read-only memory), a storage device, and other components. The controller 40 controls the operations of the dispensing head 10, the drive mechanism 10a, and the rotary drive unit 30.

In addition to the above configuration, the dispensing device 100 is provided with a magnetic unit (not illustrated). The magnetic unit includes a mounting portion on which the first well plate WP can be placed. The mounting portion of the magnetic unit is provided with a plurality of magnets that can be arranged on the outer surface of each well WL of the first well plate WP. The magnets in the magnetic unit may be permanent magnets or electromagnets. In this embodiment, the magnets in the magnetic unit are permanent magnets.

The dispensing device 100 of this embodiment is used, for example, for immunoprecipitation processing as preprocessing for analyzing and measuring target polypeptides in a biological sample with an analysis device. Such processing is described in International Publication No. WO 2018/139132. In the immunoprecipitation processing of the dispensing device 100, the dispensing head 10 is used for dispensing the liquids in the first and second well plates WP and wp, which are supported by the plurality of first support portions 21 and the second support portion 22.

Using the plurality of first well plates WP on the plurality of first support portions 21, a first reaction process, a first washing process, a first elution process, a neutralization process, a second reaction process, a second washing process, and a second elution process in the immunoprecipitation process for a biological sample are performed. Using the plurality of second well plates wp on the second support portion 22, an analysis target well preparation process to generate the substance to be analyzed on the well wl is performed. After the analysis target well preparation process, the analysis target substance in each well wl of the plurality of second well plates wp on the second support portion 22 is analyzed by an analysis device. The analysis device is, for example, a mass spectrometer. In this embodiment, the analysis device is a matrix-assisted laser desorption/ionization mass spectrometer (hereinafter referred to as “MALDI-MS”).

The first reaction process is, for example, a process in which a solution containing biological samples is brought into contact with a first antibody immobilization carrier (including a carrier and an antibody with an antigen binding site capable of recognizing a target polypeptide bound to the carrier). As the first antibody immobilization carrier, magnetic beads are used. The solution containing a biological sample is accommodated in a reagent bottle (not illustrated). In the first reaction process, initially, a solution containing a first antibody immobilization carrier is dispensed into each well WL of an unused first well plate WP out of the plurality of first well plates WP. Dispensing of the first antibody immobilization carrier into each well WL may be performed manually by the user or by using the dispensing head 10 of the dispensing device 100. Alternatively, a first well plate WP in which a solution containing a first antibody immobilization carrier is pre-contained in each well WL may be used.

Next, the dispensing head 10 of the dispensing device 100 aspirates a liquid containing a biological sample stored in a reagent bottle. Thereafter, the dispensing head 10 of the dispensing device 100 dispenses the solution containing the biological sample into each well WL of the first well plate WP accommodating the first antibody immobilization carrier. Note that this process may be performed by dispensing a solution containing a first antibody immobilization carrier into each well WL of the first well plate WP in which a solution containing a biological sample is accommodated. With this, the target polypeptide in the biological sample binds to the first antibody immobilization carrier. This produces a complex of the first antibody immobilization carrier and the target polypeptide.

The first washing process is a step of washing the complex of the first antibody immobilization carrier and the target polypeptide obtained by the first reaction process using a washing solution. As the washing solution, a neutral buffer solution containing a surfactant is used. The washing solution is accommodated in a reagent bottle (not illustrated). In the first washing process, initially, a solution containing the complex of the first antibody immobilization carrier and the target polypeptide is dispensed into each well WL of an unused first well plate WP.

Next, the dispensing head 10 of the dispensing device 100 aspirates a washing solution stored in a reagent bottle and dispenses the washing solution into each well WL of the first well plate WP in which the solution containing the complex of the first antibody immobilization carrier and the target polypeptide is accommodated. Thereby, the complex of the first antibody immobilization carrier and the target polypeptide is washed.

The first elution process is a step of dissociating the target polypeptide from the first antibody immobilization carrier by using an acidic solution and then acquiring an eluted first eluent. The acidic solution is accommodated in a reagent bottle (not illustrated). In the first elution process, initially, the solution containing the complex of the first antibody immobilization carrier and the target polypeptide washed in the first washing process is dispensed into each well WL of an unused first well plate WP.

Next, the dispensing head 10 of the dispensing device 100 aspirates the acidic solution stored in the reagent bottle and dispenses the acidic solution into each well WL of the first well plate WP in which the solution containing the complex of the first antibody immobilization carrier and the target polypeptide is accommodated. Thereby, the acidic solution and the complex (washed) of the first antibody immobilization carrier and the target polypeptide are mixed to produce a first mixed solution.

Subsequently, dissociation of the first antibody immobilization carrier and the target polypeptide in the first mixed solution is performed. For the dissociation of the first antibody immobilization carrier and the target polypeptide, a first well plate WP in which the first mixed solution is accommodated in each well WL is transferred to a magnetic unit (not illustrated). The transfer of the first well plate WP to the magnetic unit may be performed manually by the operator. Alternatively, for example, the first well plate WP may be transferred using a transfer robot capable of holding the first well plate WP by aspiration.

In the magnetic unit, a plurality of magnets of the magnetic unit (not illustrated) is placed on the outer wall surface of each well WL. This attracts the first antibody immobilization carrier (magnetic beads) in each well WL of the well plate WP to the inner wall surface of each well WL. Hereafter, this operation is referred to as a “magnetic attraction operation.” In this state, the dispensing head 10 of the dispensing device 100 aspirates the first mixed solution (supernatant) in each well WL to acquire a first eluent.

The neutralization process is a step to acquire a first purified solution in which the pH of the first eluent is made neutral by adding a neutral buffer solution to the first eluent. The neutral buffer solution is stored in a reagent bottle (not illustrated). In the neutralization process, initially, the first elution solution is dispensed into each well WL of the unused first well plate WP by the dispensing head 10 of the dispensing device 100. Next, the dispensing head 10 of the dispensing device 100 aspirates the neutral buffer solution stored in the reagent bottle and dispenses the neutral buffer solution into each well WL of the first well plate WP, which accommodates the first eluent solution. With it, the pH of the first eluent is neutralized, thereby producing a first purified solution.

The second reaction process is a step in which the first purified solution is brought into contact with the second antibody immobilization carrier (including the carrier and an antibody having an antigen binding site capable of recognizing the target polypeptide bound to the carrier) to cause the target polypeptide in the first purified solution to bind to the second antibody immobilization carrier. As the second antibody immobilization carrier, magnetic beads are used. In the second reaction process, initially, a solution containing a second antibody immobilization carrier is dispensed into each well WL of an unused first well plate WP out of the plurality of first well plates WP. Dispensing of the second antibody immobilization carrier into each well WL may be performed manually by the user or by using the dispensing head 10 of the dispensing device 100. Alternatively, a first well plate WP in which the solution containing a second antibody immobilization carrier is stored in advance in each well WL may be used.

Next, the dispensing head 10 of the dispensing device 100 aspirates the first purified solution acquired in the neutralization process. Thereafter, the dispensing head 10 of the dispensing device 100 dispenses the first purified solution into each well WL of the first well plate WP in which the solution (including the second antibody-immobilized carrier) is accommodated. Note that in this process, the process may be performed by dispensing a solution containing the second antibody immobilization carrier into each well WL of the first well plate WP in which the first purified solution is accommodated. With this, the target polypeptide in the first purified solution binds to the second antibody immobilization carrier.

The second washing step is a step of washing the second antibody immobilization carrier to which the target polypeptide has been bound using a washing solution. As the washing solution, a neutral buffer solution containing a surfactant is used. The washing solution is accommodated in a reagent bottle (not illustrated). In the second washing process, initially, a solution containing the complex of the second antibody immobilization carrier and the target polypeptide is dispensed into each well WL of an unused first well plate WP.

Next, the dispensing head 10 of the dispensing device 100 aspirates the washing solution stored in the reagent bottle and dispenses the washing solution into each well WL of the first well plate WP in which the solution containing the complex of the second antibody immobilization carrier and the target polypeptide is accommodated. With this, the complex of the second antibody immobilization carrier and the target polypeptide is washed.

The above-described first reaction process to the second washing process are performed sequentially on the first well plate WP on the first to (n−1)^{th} first support portion 21 shown in FIG. 1.

The second elution process is a step of dissociating the target polypeptide from the second antibody immobilization carrier by using an acidic solution and then acquiring the eluted second eluent. As the acidic solution in the second elution process, an organic solvent with volatility (in this embodiment, 70% acetonitrile) is used. Therefore, the second eluent after the second elution process is volatile. So, the second elution process is performed on the first well plate WP of the (n−1)^{th} first support portion 21 shown in FIG. 1. An acidic solution is accommodated in a reagent bottle (not illustrated).

In the second washing step, initially, the solution containing the complex of the second antibody immobilization carrier and the target polypeptide washed in the second washing step is dispensed into each well WL of an unused first well plate WP. Next, the dispensing head 10 of the dispensing device 100 aspirates the acidic solution stored in the reagent bottle and dispenses the acidic solution into each well WL of the first well plate WP in which the solution containing the complex of the second antibody immobilization carrier and the target polypeptide is accommodated. Thereby, the acidic solution and the complex (washed) of the second antibody immobilization carrier and the target polypeptide are mixed to produce a second mixed solution.

Subsequently, dissociation of the second antibody immobilization carrier and the target polypeptide in the second mixed solution is performed. For dissociation of the second antibody immobilization carrier from the target polypeptide, a first well plate WP in which the second mixed solution is accommodated in each well WL is transferred to a magnetic unit (not illustrated). The transfer of the first well plate WP to the magnetic unit may be performed manually by the operator or by a transfer robot or other means, as described above. In the magnetic unit, the magnetic attraction operation described above is performed.

In this state, the dispensing head 10 of the dispensing device 100 aspirates the second mixed solution (supernatant) in each well WL to acquire a second eluent. In the above, an example of the operation from the first reaction process to the second elution process is described, but the present disclosure is not limited thereto. The operations from the first reaction process to the second elution process may be performed by other operations.

The analysis target well preparation process is a process of dispensing the second eluent in each well WL of the first well plate WP on the n^{th} first support portion 21 after the second elution process to each well wl of the second well plate wp and mixing the second eluent with the reagent for MALDI-MS. The reagent for MALDI-MS is a solution containing reagents (including a matrix and additives, etc.) necessary for the analysis by an analysis device. The reagent for MALDI-MS is accommodated in a reagent bottle (not illustrated). In the analysis target well preparation process of this embodiment, the second eluent is dispensed to each well wl of the second well plate wp by dividing the eluent into four parts. The details will be discussed below.

In the analysis target well preparation process, initially, the second eluent is dispensed into each well wl of the second well plate wp by the dispensing head 10 of the dispensing device 100. Next, the dispensing head 10 of the dispensing device 100 aspirates the MALDI-MS reagent stored in the reagent bottle and dispenses the MALDI-MS reagent into each well wl of the second well plate wp in which the second eluent is accommodated. With this, a solution containing an analysis target substance is produced in each well wl of the second well plate wp. Note that this process may be performed by dispensing the second eluent into each well wl of the second well plate wp accommodating the reagent for MALDI-MS.

Thereafter, in each well wl of the second well plate wp, the second eluent in the solution containing the analysis target substance volatilizes, and the crystalline analysis target substance remains in each well wl due to volatilization of the second eluent. In the MALDI-MS, the crystalline analysis target substance remained in each well wl of the second well plate wp is irradiated with, for example, a laser beam. By doing so, the substance is ionized, and the mass spectrometry is performed.

Note that in this embodiment, magnetic beads are used as the first antibody immobilization carrier and the second antibody immobilization carrier. Thereby, in each process from the first reaction process to the analysis target well preparation process, in a case where solid-liquid separation is required for the dispensing target solution, as necessary, the supernatant may be aspirated in a state in which the magnetic attraction operation is being performed by the magnetic unit.

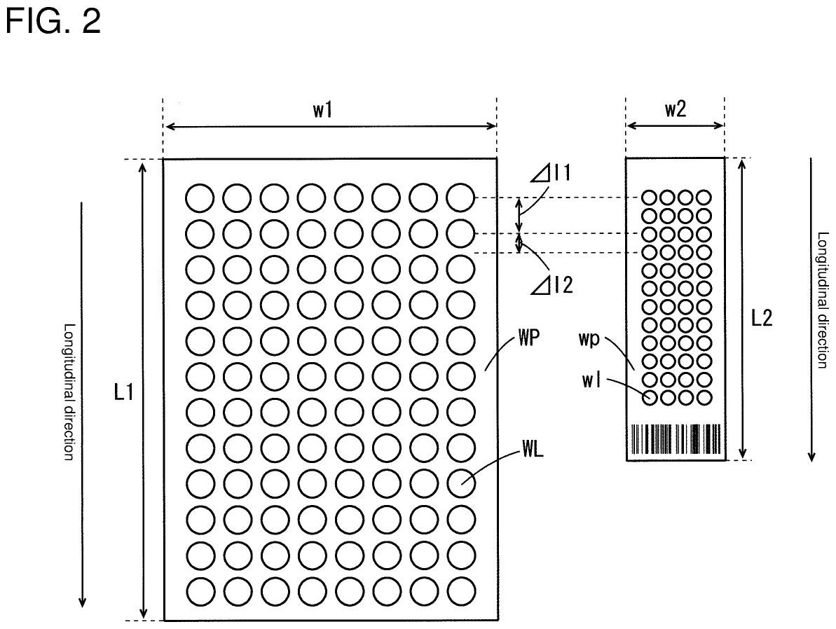

FIG. 2 to FIG. 4 are schematic plan views describing the first well plate WP and the second well plate wp. FIG. 2 shows the first well plate WP and the second well plate wp.

In FIG. 2, a plurality of wells WL of the first well plate WP are aligned in a matrix of multiple rows and multiple columns in the horizontal plane. Each column and each row are orthogonal to each other. In each row, wells WL are arranged linearly at equal intervals. In each column, wells WL are arranged linearly at equal intervals. The number of wells WL in each row is greater than the number of wells WL in each column. Thus, the direction of each row is a longitudinal direction, and the direction of each column is a transverse direction. The first well plate WP of this embodiment conforms to the microplate standard (ANSI SLAS 1-2004). The plurality of wells WL in each column and row of the first well plate WP is arranged at a first pitch ΔI1. In this embodiment, the plurality of wells WL is arranged in 12 rows and 8 columns (12×8). The first well plate WP has a length L1 in the longitudinal direction and a width wl in the transverse direction.

The plurality of wells wl of the second well plate wp is aligned in the horizontal plane in a matrix of multiple rows and multiple columns. Each column and each row are orthogonal to each other. In each column, wells wl are arranged linearly at equal intervals. In each row, wells wl are arranged linearly at equal intervals. The number of wells wl in each row is greater than the number of wells wl in each column. Thus, the direction of each row is a longitudinal direction, and the direction of each column is a transverse direction. The second well plate wp of this embodiment is configured to have a size commonly used for slide glasses. The plurality of wells wl in each row and each column of the second well plate wp is arranged at a second pitch ΔI2, which is half of the first pitch ΔI1. In this embodiment, the plurality of wells wl is arranged in 12 rows and 4 columns (12×4).

The second well plate wp has a length L2 in the longitudinal direction and a width w2 in the transverse direction. The length L2 of the second well plate wp may be shorter than the length L1 of the first well plate WP and may be approximately equal to or shorter than the width wl of the first well plate WP. The width w2 of the second well plate wp may be shorter than the length L1 of the first well plate WP or may be shorter than the width wl.

Specifically, the length L2 of the second well plate wp may be shorter than ½ times the length L1 of the first well plate WP, and may be shorter than ¼ times the width w1. The width w2 of the second well plate wp may be shorter than ¼ times the length L1 of the first well plate WP and ½ times the width w1. For the first well plate WP in this embodiment, the length L1 is about 128 mm, and the width wl is about 86 mm. For the second well plate wp in this embodiment, the length L2 is about 73 mm, and the width w2 is about 22 mm.

As described above, the outer frame portion 22b of each second support portion 22 is configured to have a size capable of fitting the first well plate WP. Therefore, in order to fix the second well plate wp on the second support portion 22, it is necessary to use an adapter capable of fixing the second well plate wp on the second support portion 22.

Here, the adapter AD for fixing the second fixing portion of the well plate wp is configured to have a size capable of being fitted in the outer frame portion 22b. In the dispensing device 100, in order to perform the dispensing operation more efficiently, it is necessary to reduce the frequency of replacing the second well plate wp placed on the second support portion 22 during a single dispensing operation. Therefore, in the dispensing device 100, in order to perform a dispensing operation more efficiently, it is required to place more second well plates wp on the adapter AD in the outer frame portion 22b of the second support portion 22.

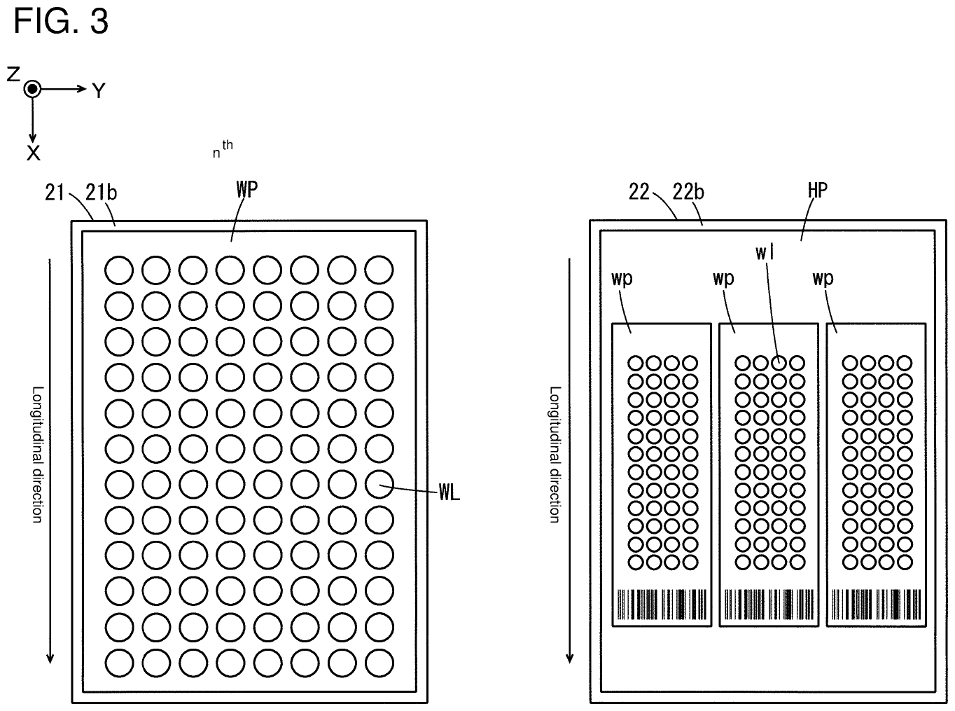

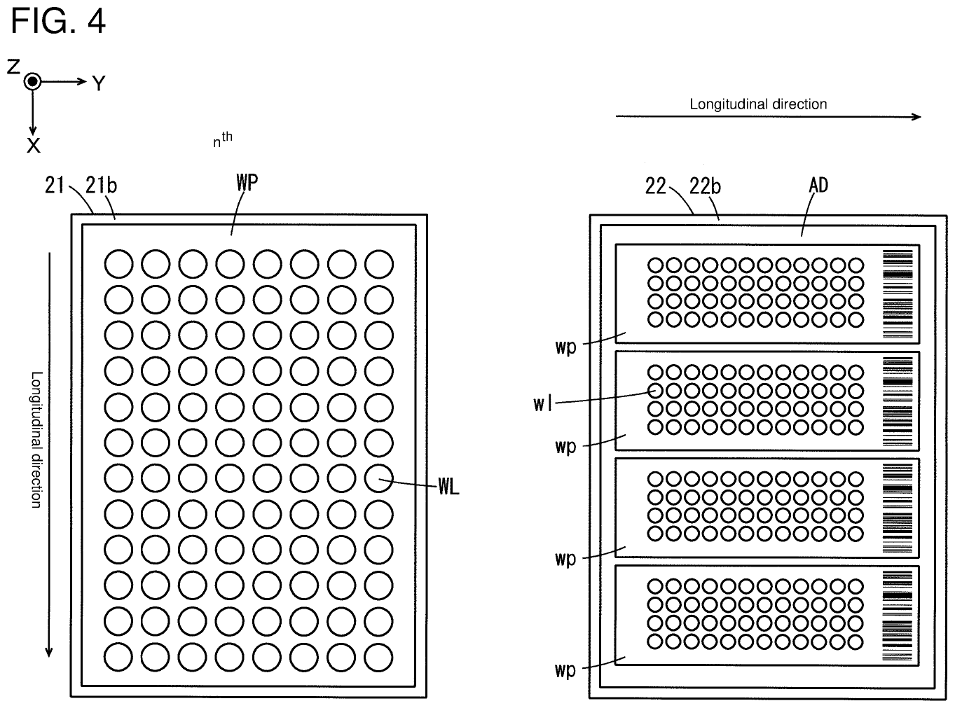

FIG. 3 shows a first example in which a plurality of second well plates wp is fixed to the second support portion 22 in the standard state. FIG. 4 shows a second example in which a plurality of second well plates wp is fixed to the second support portion 22 in the standard state. In the first example shown in FIG. 3, the second well plate wp is placed on the second support portion 22 so that the longitudinal direction of the second support portion 22 is aligned with the longitudinal direction of the second well plate wp. In this case, three second well plates wp can be placed on the second support portion 22 within the outer frame portion 22b of the second support portion 22.

On the other hand, in the second example shown in FIG. 4, the second well plate wp is placed on the second support portion 22 so that the longitudinal direction of the second support portion 22 is aligned with the transverse direction of the second well plate wp. In this case, four second well plates wp, more than in the first example shown in FIG. 3, can be placed on the second support portion 22 in the outer frame portion 22b of the second support portion 22. Therefore, in order to perform the dispensing operation more efficiently, it is ideal to place four second well plates wp on the second support portion 22 in the second example shown in FIG. 4.

However, in the state of FIG. 4, when performing the dispensing operation from the first well plate WP to each second well plate wp using the dispensing head 10 of FIG. 1, the arrangement of wells WL in each row (longitudinal direction) of the n^{th} first well plate WP and each row (longitudinal direction) of the second well plate wp in the Z-direction view are different from each other. Therefore, the arrangement of tip attachments 12 in each row of the dispensing head 10 coincides with the arrangement of wells WL in each row of the n^{th} first well plate WP, but not with the arrangement of wells wl in each row of the second well plate wp. In this case, the dispensing operation of the dispensing head 10 from the n^{th} first well plate WP to each second well plate wp cannot be performed efficiently.

Specifically, in the situation shown in FIG. 4, the number of the plurality of wells WL aligned in the X-direction of the n^{th} first well plate WP is three times the number of the plurality of wells wl aligned in the X-direction of each second well plate wp, and the pitch of the plurality of wells WL aligned in the X-direction of the first well plates WP is two times the pitch of the plurality of wells wl aligned in the X-direction of each second well plate wp. In this case, with a single dispensing operation of the dispensing head 10, the liquid aspirated from a plurality of wells WL aligned in the X-direction on the first well plate WP is dispensed into only some wells wl aligned in the X-direction on the second well plate wp. This reduces the number of dispensing target wells WL, wl by a single dispensing operation, which requires a large number of dispensing operations to be performed. As a result, the throughput of the dispensing device 100 is reduced.

When performing multiple dispensing operations for the n^{th} first well plate WP and multiple second well plates wp, the residence time of the second eluent in the dispensing target well WL of the n^{th} first well plate WP differs in each dispensing operation.

For example, the residence time of the second eluent in the dispensing target well WL in the initial dispensing operation is the shortest, and the residence time of the second eluent in the dispensing target well WL in the last dispensing operation is the longest. For this reason, the volatilization amount of the second eluent in the dispensing target well WL in the initial dispensing operation is small, while the volatilization amount of the second eluent in the dispensing target well WL in the last dispensing operation is large. This results in the difference in the composition, etc., of the substance in each well wl of the second well plate wp. In the operation example described below, the difference in the residence time of the liquid in the plurality of wells WL of the n^{th} first well plate WP is suppressed to be short.

### (2) One Example of Control by Controller 40

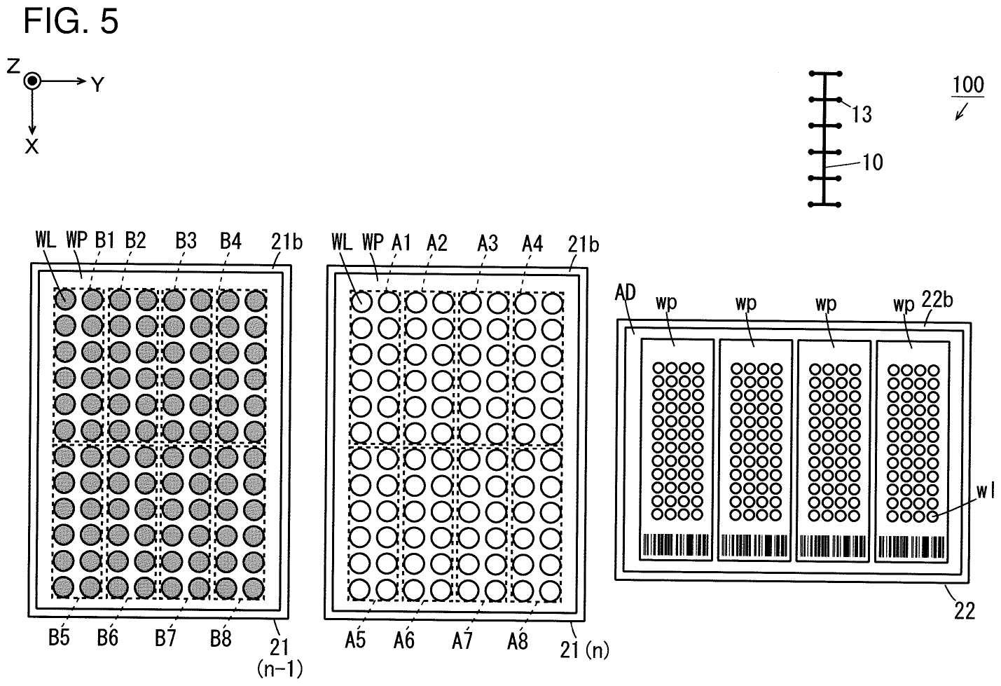

FIG. 5 to FIG. 11 are schematic plan views each showing a state on the first and second well plates WP, wp by the control of the controller 40. FIG. 5 to FIG. 11 show the first well plate WP on the (n−1)^{th} first support portion 21, the first well plate WP on the n^{th} first support portion 21(n), and four pieces of the second well plates wp on the second support portion 22. Further, when a liquid is present in wells WL, wl, each well WL, wl is hatched. The controller 40 shown in FIG. 1 controls the dispensing head 10, the drive mechanism 10a, and the rotary drive unit 30 so that the following operations are performed.

In this embodiment, as shown in FIG. 5, the rotary drive unit 30 (see FIG. 1) rotates the second support portion 22 by 90 degrees from the standard state in FIG. 4 so that the longitudinal direction of each second well plate wp (the direction with the greater number of wells wl) substantially coincides with the X direction. In this case, the dispensing head 10 can dispense between more wells WL, wl in a single dispensing operation.

Each row of the first well plate WP includes H pieces of wells (“H” is an integer greater than or equal to 2) WL. In this embodiment, each row of the first well plate WP includes 2H pieces of wells WL. In this example, “H” is 6. The second well plate wp includes M pieces of wells (“M” is an integer greater than or equal to 2) wl. In this example, “M” is (12×4).

In this example, the second elution process is performed in each well WL of the n^{th} first well plate WP. The second eluent acquired by the second elution process is volatile. The volatilization of the second eluent in each well WL of the first well plate WP affects the later analysis. As described below, the second eluent in each well WL of the n^{th} first well plate WP is divided and dispensed into four pieces of wells wl of the second well plate wp. Considering these points, the dispensing operation is performed efficiently as follows.

The plurality of wells WL of the n^{th} first well plate WP is divided into eight regions A1 to A8. Each region A1 to A8 includes H (“H” is an integer greater than or equal to 2) pieces of wells WL. In this example, “H” is 12 (6×2). In this embodiment, each of the regions A1 to A8 corresponds to a first dispensing unit.

The arrangement of the wells WL of the (n−1)^{th} first well plate WP is the same as the arrangement of the wells WL of the n^{th} first well plate WP. The plurality of wells WL of the (n−1)^{th} first well plate WP is divided into eight regions B1 to B8 as in the n^{th} well plate WP. In this embodiment, each of the plurality of regions B1 to B8 of the (n−1)^{th} first well plate WP corresponds to a third dispensing unit.

Each of the second well plates wp includes M (“M” is an integer greater than or equal to 2) pieces of wells wl. In this example, “M” is (12×4). M is m times H (“m” is an integer greater than or equal to 2). In this example, “m” is 4. The M pieces of wells wl of the second well plate wp are classified into m sets. Each set includes H pieces of wells wl. In this embodiment, each second well plate wp corresponds to a second dispensing unit.

In the example shown in FIG. 5, in each second well plate wp, the first set is composed of six pieces of wells wl every other one in the first row and six pieces of wells wl every other one in the third row. The second set is composed of six pieces of wells wl every other remaining one in the first row and six pieces of wells wl every other remaining one in the third row. The third set is composed of six pieces of wells wl every other one in the second row and six pieces of wells wl every other one in the fourth row. The fourth set is composed of six pieces of wells wl every other remaining one in the second row and six wells wl every other remaining one in the fourth row.

Twelve pieces of dispensing tips 13 are attached to the multiple tip attachments 12 of the dispensing head 10 so as to correspond to the array (6×2) of wells WL in each region A1 to A8. FIG. 5 to FIG. 11 schematically illustrate the array of 12 pieces of tip attachments 12 to which the dispensing tips 13 are attached to the dispensing head 10.

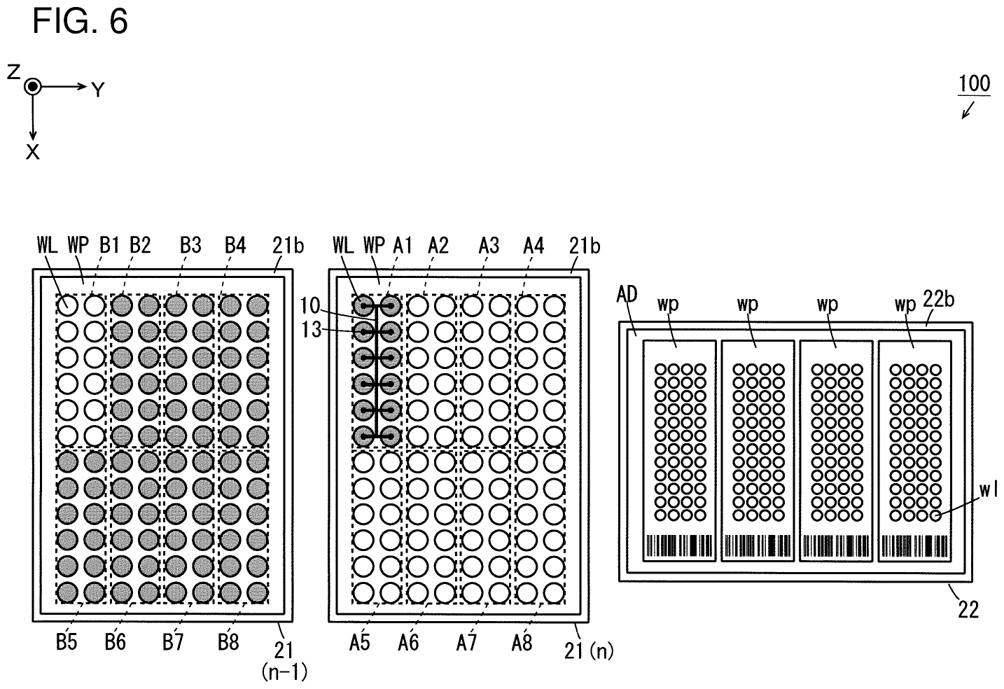

In this state, the liquid after completion of the second washing process is aspirated from 12 pieces of wells WL in the region B1 of the (n−1)^{th} first well plate WP into the 12 pieces of dispensing tips 13 of the dispensing head 10. Subsequently, the liquid aspirated in 12 pieces of dispensing tips 13 is dispensed into 12 pieces of wells WL in the region A1 of the n-th first well plate WP, as shown in FIG. 6. Here, the second elution process is performed in 12 pieces of wells WL in the region A1 of the n^{th} first well plate WP.

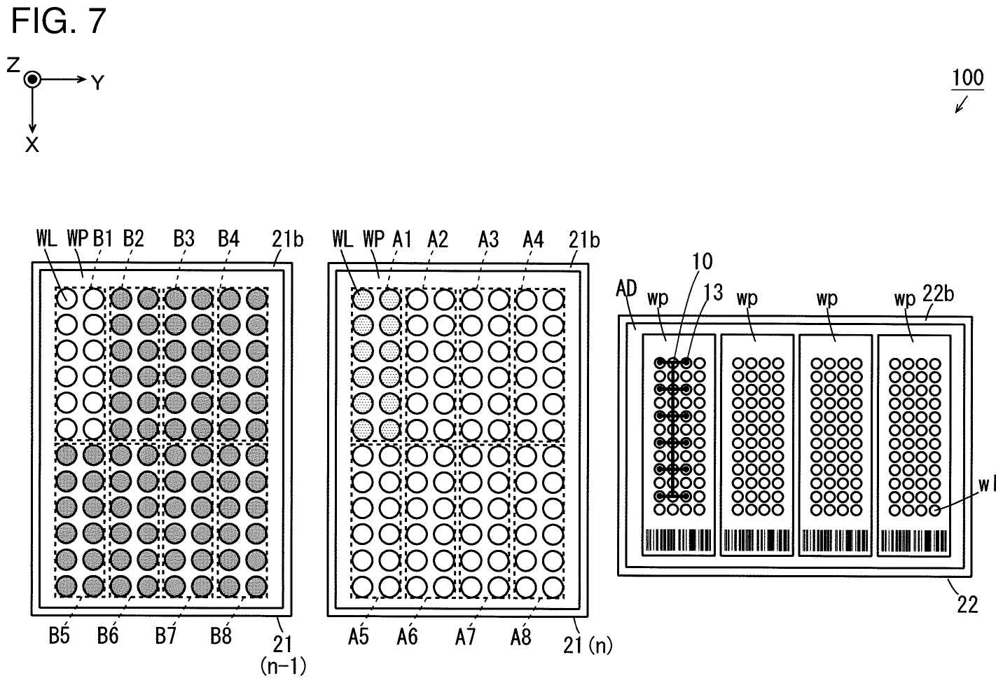

After completion of the second elution process, a part of the second eluent is aspirated from 12 pieces of wells WL in the region A1 of the n^{th} first well plate WP into 12 pieces of dispensing tips 13 of the dispensing head 10. Next, as shown in FIG. 7, 12 pieces of dispensing tips 13 of the dispensing head 10 are moved above the first second well plate wp. The second eluent aspirated into each of 12 pieces of dispensing tips 13 is dispensed into 12 pieces of wells wl of the first set of 12 pieces of wells of the second well plate wp.

Next, 12 pieces of dispensing tips 13 of the dispensing head 10 are moved above the n^{th} first well plate WP, and the remaining part of the second eluent is aspirated into the 12 pieces of dispensing tips 13 of the dispensing head 10 from the 12 pieces of wells WL in the region A1. Subsequently, the 12 pieces of dispensing tips 13 of the dispensing head 10 are moved above the first second well plate wp, and the second eluent aspirated in each of the 12 pieces of dispensing tips 13 is dispensed into 12 pieces of wells of the second set of the second well plate wp.

Similarly, aspirating of the second eluent from the wells WL of the region A1 of the n^{th} first well plate WP and dispensing of the second eluent into the third set of 12 pieces of wells wl of the first second well plate wp are performed. And, aspirating of the second eluent from the wells WL in the region A1 of the n^{th} first well plate WP and dispensing of the second eluent into the fourth set of 12 pieces of wells wl of the first second well plate wp are performed.

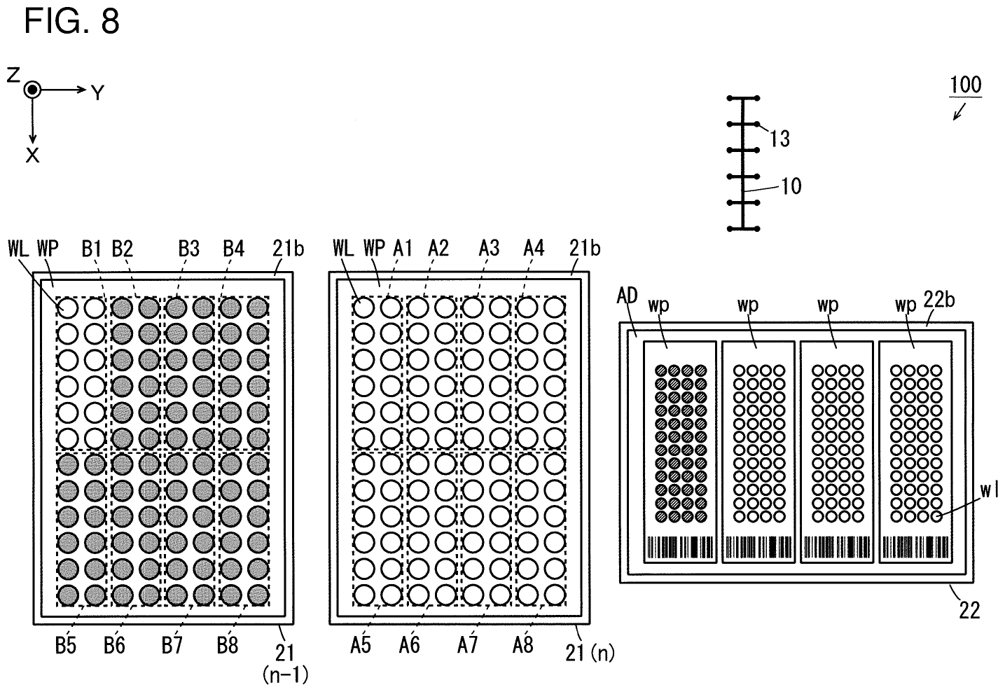

In this manner, by four dispensing operations, the second eluent aspirated from 12 pieces of wells WL in the region A1 of the n^{th} first well plate WP is accommodated in 48 pieces of wells wl of the first second well plate wp, as shown in FIG. 8.

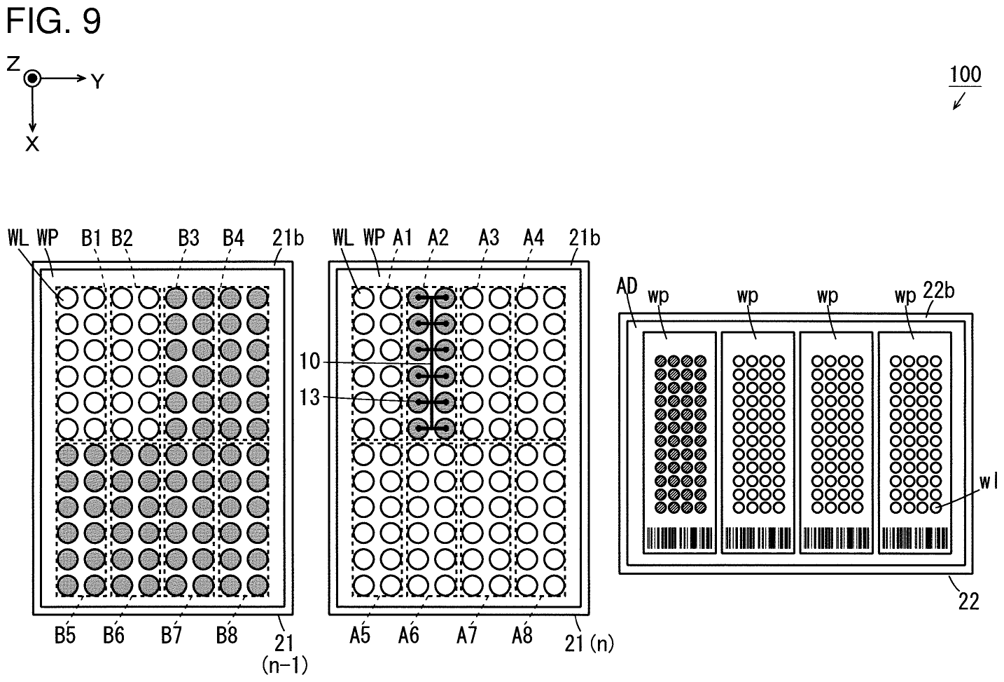

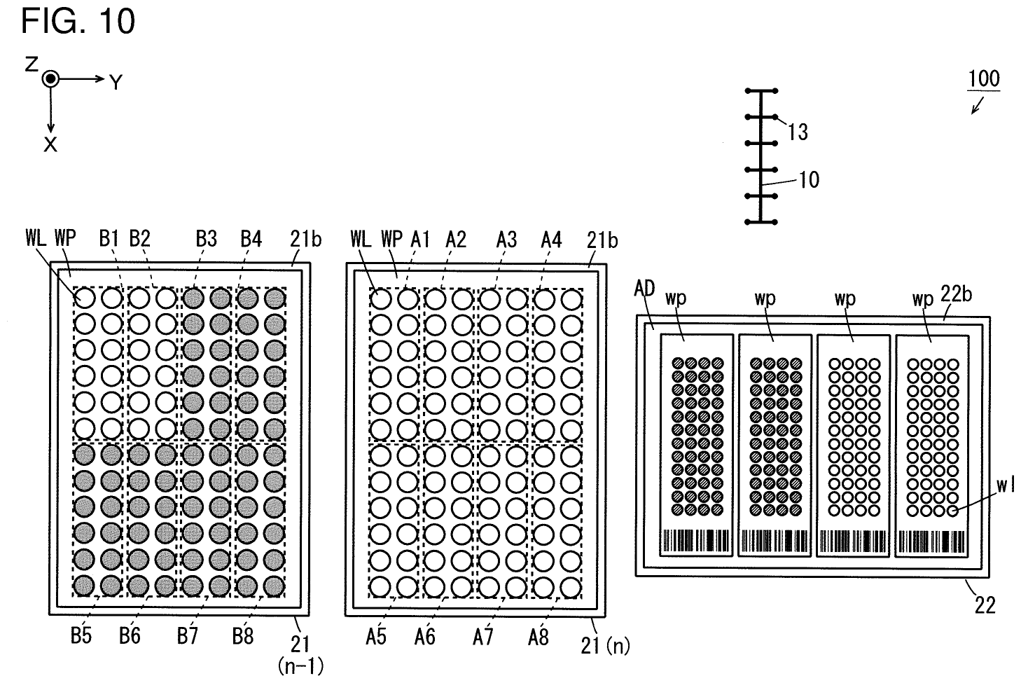

Subsequently, as shown in FIG. 9, a series of dispensing operations are performed for the region B2 of the (n−1)^{th} first well plate WP, the region A2 of the n^{th} first well plate WP, and the second well plate wp. In this manner, as shown in FIG. 10, the second eluent aspirated from 12 pieces of wells WL in the region A1 of the n^{th} first well plate WP is accommodated in 48 pieces of wells wl of the second well plate WP.

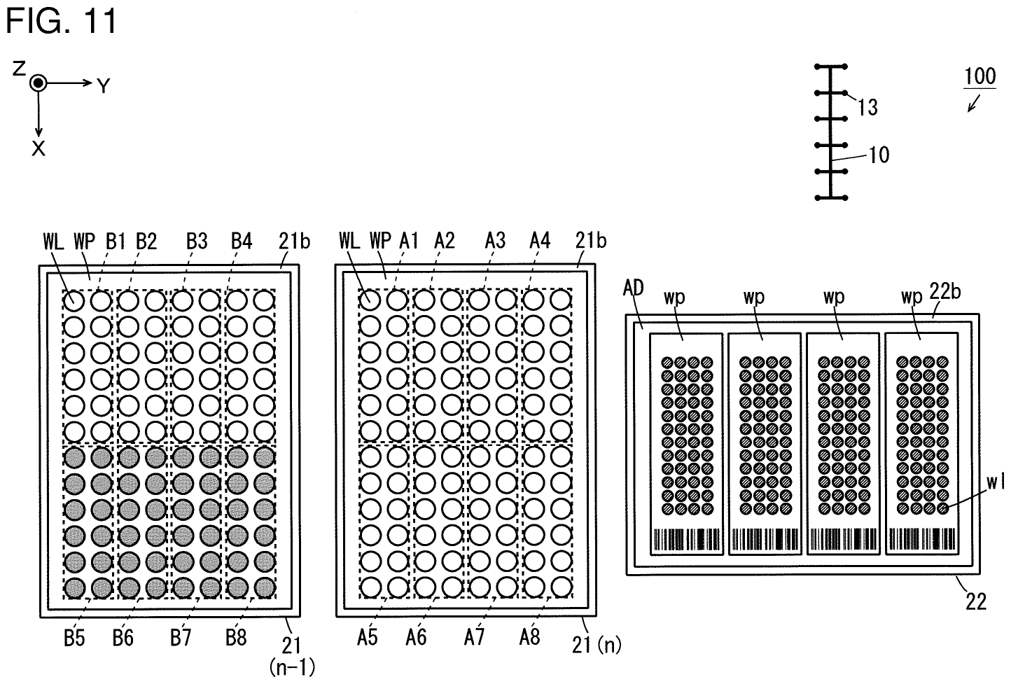

Subsequently, a series of dispensing operations are performed for the region B3 of the (n−1)^{th} first well plate WP, the region A3 of the n^{th} first well plate WP, and the third second well plate wp. Lastly, a series of dispensing operations are performed for the region B4 of the (n−1)^{th} first well plate WP, the region A4 of the n^{th} first well plate WP, and the fourth second well plate wp. As a result, as shown in FIG. 11, the second eluent is accommodated in the wells wl of the first to fourth second well plates wp. In the above-described dispensing operations, the difference in the residence time of the second eluent in the multiple regions A1 to A4 of the n^{th} first well plate WP is suppressed to be small.

Note that for the region B5 to B8 of the (n−1)^{th} first well plate WP and the region A5 to A8 of the n^{th} first well plate WP, the above-described operations will be performed after the plurality of second well plates wp supported by the second support portion 22 is replaced with a new plurality of second well plates wp. The replacement of the new second well plate wp may be manually performed by the operator, or it may be replaced using a transfer robot capable of transporting the adapter AD to which the second well plate wp is fixed.

### (3) Effects of Embodiment

In the above-described dispensing device 100, even in the case where the alignment direction of the plurality of tip attachments 12 of the dispensing head 10 and the alignment direction of the plurality of wells wl of each second well plate wp supported by the second support portion 22 are different, the second support portion 22 is rotated relative to the dispensing head 10 by the rotary drive unit 30. By doing so, the alignment direction of the plurality of tip attachments 12 of the dispensing head 10 can be aligned with the alignment direction of the plurality of wells wl of each second support portion wp supported by the second support portion 22. Therefore, it is possible to aspirate or dispense the liquid with a simple configuration and dispense operation for various well plates with different alignment directions of the plurality of wells wl while suppressing the cost increase.

Since the second support portion 22 rotates by 90 degrees, the longitudinal direction of the plurality of tip attachments 12 of the dispensing head 10, the longitudinal direction of the wells WL of the first well plate WP supported by the first support portion 21, and the longitudinal direction of the wells wl of the second well plate wp supported by the second support portion 22 can be aligned with each other. Thus, even in the case where the longitudinal direction of the plurality of wells WL of the first well plate WP and the longitudinal direction of the plurality of wells wl of the second well plate wp are orthogonal to each other, it is possible to easily perform the dispensing from each well WL of the first well plate WP to each well wl of the second well plate wp.

Further, by way of from each well WL in the region B1 to B8 of the first well plate WP of the (n−1)^{th} first support portion 21 to each well WL in the region A1 to A8 of the first well plate WP of the n^{th} first support portion 21, the transfer of the liquid is continuously performed from the first set of wells wl to the fourth set of wells wl of the second well plate wp.

In this case, the liquid dispensed into each well WL in one region out of the regions A1 to A8 is aspirated and dispensed into each well wl of one second well plate wp, and then the liquid is dispensed into each well WL in the other regions A1 to A8. Therefore, the time during which the liquid is accommodated in each well WL in one of the regions A1 to A8 becomes equal to the time during which the liquid is accommodated in each well WL in the other regions A1 to A8. Thereby, even in the case where the liquid accommodated in the plurality of wells WL of the n^{th} well plate WP changes over time, like a liquid having volatile properties, the difference in the processing results of the liquid accommodated in the first well plate WP is suppressed.

### (4) Modifications

In the above-described embodiment, an example is shown in which four pieces of second well plates wp are fixed on the adapter AD, which can be accommodated within the outer frame portion 22b. When replacing the adapter AD to which the second well plates wp are fixed using a transfer robot, depending on the accuracy of the transfer robot, it may be necessary to change the outer frame portion 22b to an outer frame portion having a size larger than the adapter AD. On the other hand, in the case where the outer frame portion 22b is larger than the adapter AD, when the second support portion 22 is rotated by the rotary drive unit 30, the adapter AD moves freely within the outer frame portion 22b. Therefore, there is a possibility that the position of the wells wl of the second well plate wp on the adapter AD shifts from its normal position at which dispending can be performed by the dispensing head 10.

In this case, it becomes difficult to accurately perform the dispensing operations as shown in FIG. 5 to FIG. 11. Thus, the realization of the replacement of the adapter AD to which the second well plate wp is fixed using a transfer robot conflicts with the requirement for accurately performing the dispensing operation. It is possible to achieve these issues by using a new drive source to fix the adapter AD while increasing the size of the outer frame portion 22b. However, this is not realistic, considering the increase in cost due to the increase in the number of parts and the complexity of the control. In the following posture change device according to the following modification, it is possible to realize the replacement of the adapter AD to which the second well plate wp is fixed using a transfer robot while keeping the cost low and realize accurate dispensing operations.

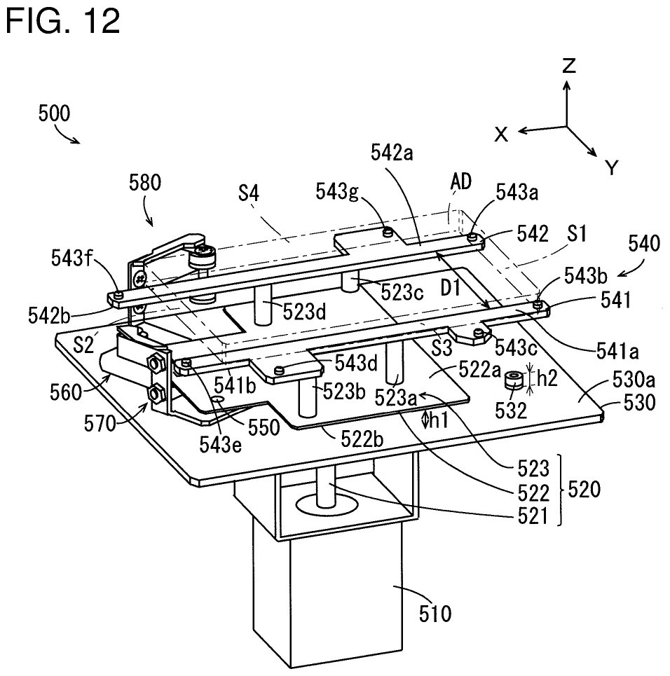

FIG. 12 to FIG. 17 are diagrams describing the configuration of a posture change device used in a modification. FIG. 12 shows a perspective view of the posture change device 500. In the modification, the posture change device 500 is used in place of the rotary drive unit 30, the connection member 31, and the second support portion 22 of the dispensing device 100 of the above-described embodiment. The posture change device 500 has a rotary drive unit 510, a connection member 520, a fixing plate 530, and a support portion 540.

The rotary drive unit 510 is, for example, a pulse motor. The connection member 520 is connected to the rotary drive unit 510. The connection member 520 includes a first rotation shaft 521, a rotation plate 522, and a plurality of connection members 523. The fixing plate 530 is a plate-like member having a top surface 530a and a bottom surface. The fixing plate 530 has a through-hole (not illustrated) penetrating through the top surface 530a and the bottom surface.

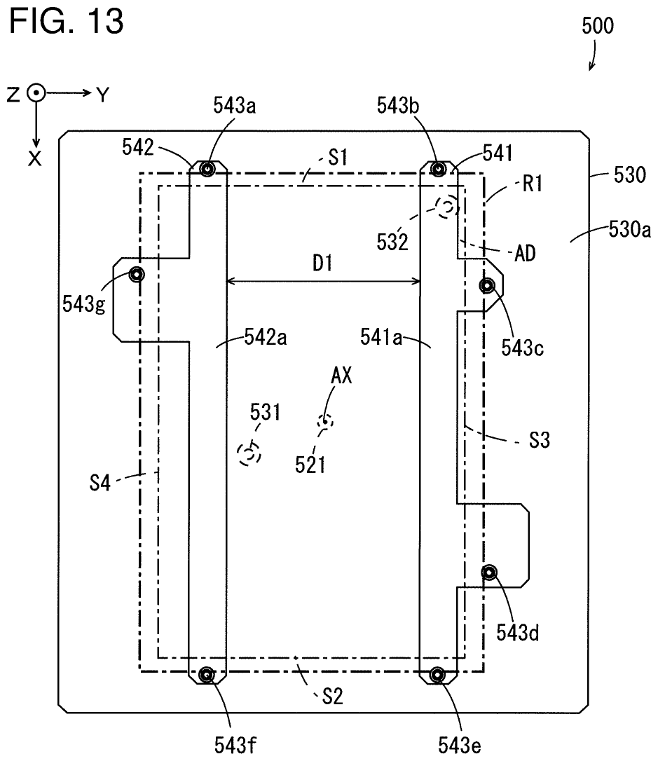

The first rotation shaft 521 of the connection member 520 is a rod-shaped member that extends in the Z-direction with a first axis AX (see FIG. 13 below) as its axis center. One end of the first rotation shaft 521 is connected to the rotary drive unit 510. The rotation plate 522 is a plate-like member having a top surface 522a and a bottom surface 522b. The other end of the first rotation shaft 521 is fixed to the bottom surface 522b of the rotation plate 522 via a through-hole (not illustrated) formed in the fixing plate 530. The other end of the first rotation shaft 521 and the bottom surface 522b of the rotation plate 522 may be fixed, for example, by welding or by bolts or the like.

The bottom surface 522b of the rotation plate 522 is located above the top surface 530a of the fixing plate 530. The height at which the bottom surface 522b of the rotation plate 522 and the top surface 530a of the fixing plate 530 are separated is h1. The top surface 530a of the fixing plate 530 is provided with a first fixing portion 531 (see FIG. 13) and a second fixing portion 532. The first fixing portion 531 and the second fixing portion 532 are projections each protruding in the upward direction (Z-direction) from the top surface 530a of the fixing plate 530. The first fixing portion 531 and the second fixing portion 532 are integral with the fixing plate 530 and are made of the same material. The first fixing portion 531 and the second fixing portion 532 may be configured by bolts or other fixing members that can be fixed to the top surface 530a.

The height h2 at which the first fixing portion 531 and the second fixing portion 532 protrude from the top surface 530a is set to a height that is lower than the height h1 and interferes with the arm 560 described below. This allows the rotation plate 522 to rotate above the first fixing portion 531 and the second fixing portion 532. Note that in the example shown in FIG. 12, the first fixing portion 531 is located below the rotation plate 522, so it is not illustrated in the figure. The details of the first fixing portion 531 and the second fixing portion 532 will be described below.

At predetermined positions on the top surface 522a of the rotation plate 522, one ends of a plurality of connection members 523a to 523d are fixed to the top surface 522a. The one ends of the connection members 523a to 523d and the rotation plate 522 may be fixed, for example, by welding, or may be fixed by bolts or other means. The plurality of connection members 523a to 523d extend in the upward direction (Z-direction) from the top surface 522a of the rotation plate 522. The lengths of the plurality of connection members 523a to 523d are equal.

The support portion 540 includes a pair of support plates 541 and 542. The support plate 541 is a plate-like member having a top surface 541a and a bottom surface 541b and extending in the X-direction. The other (upper) ends of the connection members 523a and 523b are fixed to the bottom surface 541b of the support plate 541. The bottom surface 541b of the support plate 541 and the other ends of the connection members 523a and 523b may be fixed by welding or by bolts, for example. The support plate 542 is a plate-like member having a top surface 542a and a bottom surface 542b and extending in the X-direction. The other (upper) ends of the connection members 523c and 523d are fixed to the bottom surface 542b of the support plate 542. The bottom surface 542b of the support plate 542 and the other ends of the connection members 523c and 523d may be fixed by welding or by bolts, for example. With this, the first rotation shaft 521 and the rotation plate 522, which constitute the connection member 520, and the support plate 541 and 542 rotate integrally when driven by the rotary drive unit 510.

The top surface 541a of the support plate 541 and the top surface 542a of the support plate 542 are parallel in the X-Y plane and arranged at the same height with respect to the Z-direction. The adapter AD, to which four pieces of second well plates wp (see FIG. 1, etc.) are fixed, is rectangular in shape with sides S1 to S4. The lengths of the support plates 541 and 542 in the X-direction are set to be longer than the length of the adapter AD in the longitudinal direction (lengths of sides S3 and S4) in plan view. The support plates 541 and 542 are separated in the Y-direction. The distance D1 between the support plate 541 and the support plate 542 in the Y-direction is set to be shorter than the length of the adapter AD in the transverse direction (length of the side S1, S2) in plan view. In this way, the adapter AD is placed in a horizontal posture on the support plate 541 and the support plate 542, straddling the top surface 541a of the support plate 541 and the top surface 542a of the support plate 542.

FIG. 13 shows a plan view of the posture change device 500. In FIG. 13, in order to describe the relation between the support plates 541 and 542 and the adapter AD, the fixing plate 530 and the support plates 541 and 542 are shown in solid lines, the adapter AD is shown in single dotted lines, and the other components are not omitted from the illustration. A plurality of projections 543a to 543g protruding in the Z-direction are provided on the top surface 541a of the support plate 541 and the top surface 542a of the support plate 542.

Specifically, the projections 543a, 543f, and 543g are provided on the top surface 542a of the support plate 542, and the projections 543b, 543c, 543d, and 543e are provided on the top surface 541a of the support plate 541. The region R1 indicated by the thick single-dotted line is a hypothetical region tangential to each of the plurality of projections 543a to 543g, and is a region where the adapter AD transferred by the transfer robot can be placed. The region R1 is rectangular in plan view and is set to be larger than the circumference of the adapter AD. In other words, the positions where the plurality of projections 543A to 543G are provided are predetermined so that the region R1 becomes larger than the circumference of the adapter AD.

Of the plurality of projections 543a to 543g, the projections 543a and 543b are provided at positions facing the side S1 of the adapter AD. The positions where the projections 543a and 543b are provided are predetermined to hold the adapter AD to be placed on the support plates 541 and 542 at the desired position. Of the plurality of projections 543a to 543g, the projections 543c and 543d are provided at positions facing the side S3 of the adapter AD. The positions where the projections 543c and 543d are provided are predetermined to hold the adapter AD to be placed on the support plates 541 and 542 at the desired position. Of the plurality of projections 543a to 543g, the projections 543e and 543f are provided at positions facing the side S2 of the adapter AD. Of the plurality of projections 543a to 543g, the projections 543g is provided at a position facing the side S4 of the adapter AD.

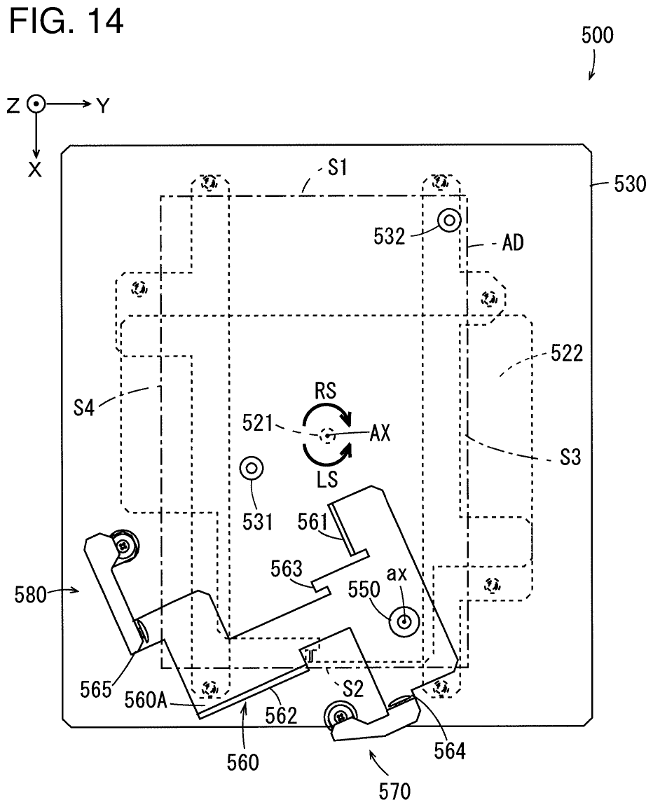

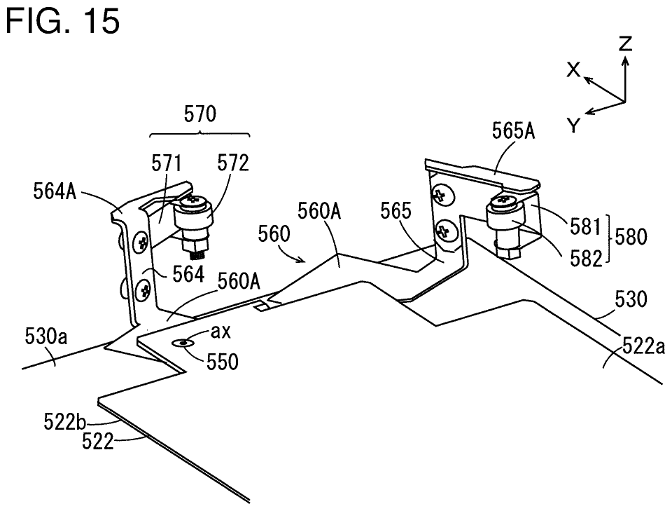

Returning to FIG. 12, the posture change device 500 is further provided with a second rotation shaft 550, an arm 560, a first pressing portion 570, and a second pressing portion 580. FIG. 14 shows a plan view of the posture change device 500. In FIG. 14, the fixing plate 530, the second rotation shaft 550, the arm 560, the first pressing portion 570, and the second pressing portion 580 are shown in solid lines, the adapter AD is shown in single dotted lines, the support plates 541 and 542, the rotation plate 522 are shown in dotted lines, and the other components are omitted from the illustration. FIG. 15 shows an enlarged perspective view of the second rotation shaft 550, the arm 560, the first pressing portion 570, and the second pressing portion 580 of the posture change device 500. In FIG. 15, components other than the fixing plate 530, the second rotation shaft 550, the arm 560, the first pressing portion 570, and the second pressing portion 580 are omitted from the illustration.

As shown in FIG. 14 and FIG. 15, the second rotation shaft 550 is a rod-shaped member extending in the Z-direction with a second axis ax as an axis, which is parallel to a first axis AX (rotation shaft of the rotary drive unit 510). One end (upper end) of the second rotation shaft 550 is fixed to the rotation plate 522, and the other end (lower end) of the second rotation shaft 550 is connected to the arm 560. The arm 560 is a plate-shaped member. The arm 560 is located between the bottom surface 522b of the rotation plate 522 and the top surface 530a of the fixing plate 530 and is connected to the second rotation shaft 550 so as to be rotatable about the second axis ax with respect to the rotation plate 522. Thereby, the arm 560 can be rotated integrally with the support plates 541 and 542 about the first axis AX by the drive of the rotary drive unit 510. Further, the arm 560 is rotatable about the second axis ax with respect to the rotation plate 522, and therefore, the arm 560 and the support plates 541 and 542 are rotatable relatively about the second axis ax.

The arm 560 includes a body portion 560A, a first contact portion 561, a second contact portion 562, a connecting projection 563, a first connection portion 564, and a second connection portion 565. The first contact portion 561 is a portion that comes into contact with the first fixing portion 531 protruding from the top surface 530a of the fixing plate 530 when the first rotation shaft 521 is rotated to the right side RS (clockwise) about the first axis AX by the rotary drive unit 510. The second contact portion 562 is a portion that comes into contact with the second fixing portion 532 protruding from the top surface 530a of the fixing plate 530 when the first rotation shaft 521 is rotated to the left side LS (counterclockwise) about the first axis AX by the rotary drive unit 510.

The first connection portion 564 is located on the side S2 of the adapter AD placed on the support plates 541 and 542 and is a portion curved in the Z-direction from the body portion 560A. The first pressing portion 570 is fixed to the first connection portion 564.

Specifically, as shown in FIG. 15, the first pressing portion 570 includes a leaf spring 571 and a bearing 572. The leaf spring 571 is made of metal and has a flat plate shape extending in the horizontal direction. In the example of FIG. 15, an example is shown in which one end of the leaf spring 571 is fixed to the first connection portion 564 by two bolts. The leaf spring 571 is, for example, a plate spring with spring characteristics, and when the other end of the leaf spring 571 is curved in a direction bending from one end, a force acts on the other end of the leaf spring 571 to return to a flat plate shape. At the other end of the leaf spring 571, a bearing 572 capable of rotating about a shaft extending in the Z-direction is provided. The bearing 572 is held at a height at which it can come into contact with the side S2 of the adapter AD placed on the support plates 541 and 542. An upper cover 564A is connected above the first connection portion 564. The upper cover 564A overlaps the leaf spring 571 in plan view and covers the side (upward-facing side) of the leaf spring 571.

Generally, a leaf spring is made of metal and is formed to have a thickness that allows plastic deformation. Therefore, the thickness of the leaf spring is thin. For this reason, the sides of the leaf spring are sharp. When a person working on the dispensing device 100 handles the posture change device 500, the upper cover 564A can prevent unintended contact with the leaf spring 571.

The second connection portion 565 is located on the side S4 of the adapter AD placed on the support plates 541 and 542 and is a portion curved in the Z-direction from the body portion 560A. The second pressing portion 580 is fixed to the second connection portion 565.

Specifically, the second pressing portion 580 includes a leaf spring 581 and a bearing 582. The leaf spring 581 has a flat plate shape extending in the horizontal direction. In FIG. 15, an example is shown in which one end of the leaf spring 581 is fixed to the second connection portion 565 with two bolts. The leaf spring 581 is, for example, a plate spring with spring characteristics, and when the other end of the leaf spring 581 is curved in a direction bending from one end, a force acts on the other end of the leaf spring 581 to return it to a flat plate shape. At the other end of the leaf spring 581, a bearing 582 capable of rotating about a shaft extending in the Z-direction is provided. The bearing 582 is held at a height at which it can come into contact with the side S4 of the adapter AD placed on the support plates 541 and 542. Above the second connection portion 565, an upper cover 565A is connected at a position overlapping the leaf spring 581 in plan view. The effect of having the upper cover 565A is the same as that of the upper cover 564A.

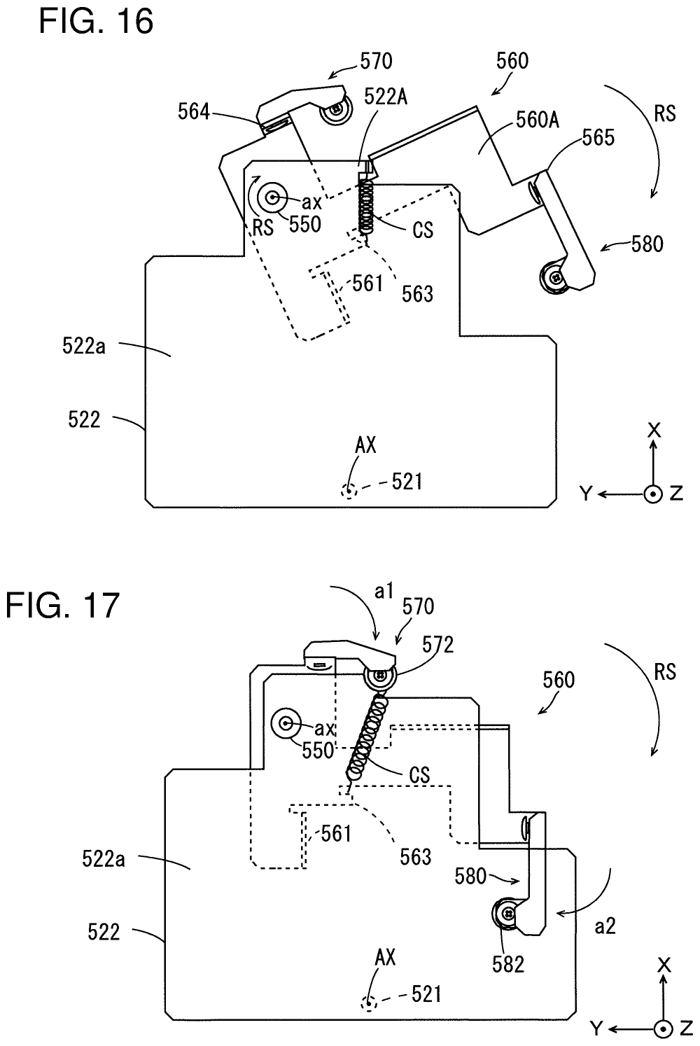

FIG. 16 and FIG. 17 show a plan view of the posture change device 500, and other configurations are omitted from the illustration in order to describe the connection relation between the rotation plate 522 and the arm 560. As described above, the rotation plate 522 and the arm 560 overlap in plan view. In FIG. 16 and FIG. 17, the portion of the arm 560 that overlaps the rotation plate 522 in plan view is indicated by a dotted line. The rotation plate 522 includes a connecting projection 522A. The connecting projection 522A of the rotation plate 522 and the connecting projection 563 of the arm 560 located below the rotation plate 522 are connected by a spring PS located between the rotation plate 522 and the arm 560 in the Z-direction. The spring PS is a general tension coil spring, which is a spring that operates under a tensile load. The spring PS acts to contract when subjected to a tensile load from both ends thereof.

For example, it is assumed that a rotation force is applied to the arm 560 to the right side RS (clockwise) about the second axis ax. In this case, as shown in FIG. 17, the entire arm 560 rotates to the right side RS (clockwise) about the second axis ax with respect to the rotation plate 522. In other words, the arm 560 and the rotation plate 522 rotate relative to each other. When a force to rotate to the right side RS (clockwise) about the second axis ax of the second rotation shaft 550 is continuously applied, the first pressing portion 570 rotates about the second axis ax as shown by arrow a1, and the second pressing portion 580 rotates about the second ax as shown by the arrow a2.

On the other hand, the rotation plate 522 and the connecting projection 563 of the arm 560 are connected by the spring PS provided between the rotation plate 522 and the arm 560. Therefore, when the application of the force to rotate to the right side RS (clockwise) is released, the contraction of the spring PS causes the arm 560 to rotate to the left side (counterclockwise), returning to the state shown in FIG. 16. Consequently, as shown in FIG. 14, unless a force is applied to the arm 560, it remains in the state shown in FIG. 16. In other words, the bearing 572 of the first pressing portion 570 and the bearing 582 of the second pressing portion 580 do not enter into the region R1 and do not contact the adapter AD (see FIG. 12). Hereafter, this state is referred to as the released state.

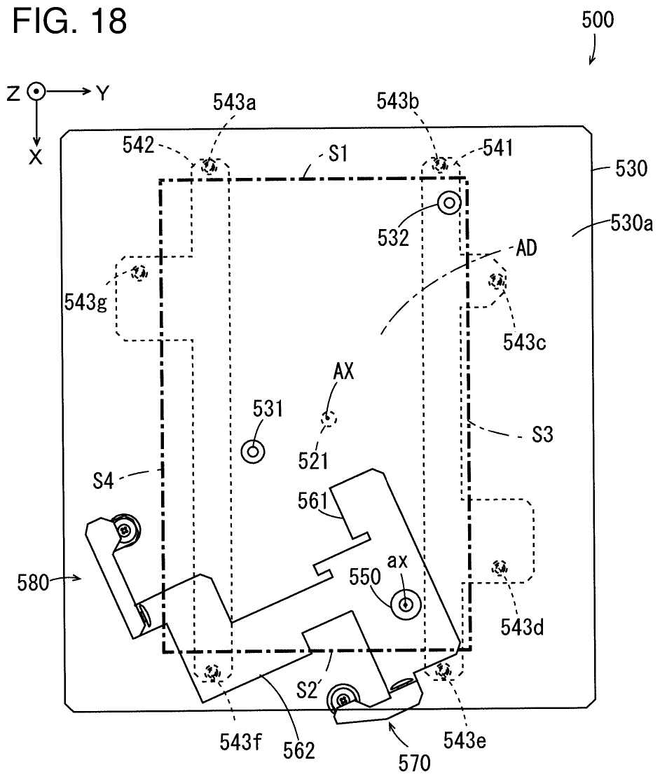

FIG. 18 to FIG. 23 are diagrams describing the operation of the posture change device 500. In FIG. 18 to FIG. 23, in order to describe the positional relation between the adapter AD on the support plates 541 and 542 and the arm 560 and the support plates 541 and 542 during the operation of the posture change device 500, other configurations are omitted from the illustration. The operation of the posture change device 500 may be realized by the control of the controller 40 of the dispensing device 100 of the above-described embodiment, or by the control of another controller different from the controller 40 of the dispensing device 100. In this example, the operation of the posture change device 500 is realized by the control of the controller 40.

Initially, as shown in FIG. 18, the posture change device 500 is in a released state. In this state, the adapter AD fixed by the second well plate wp is transferred to the support plates 541 and 542 by a transfer robot (not illustrated). The transfer robot transfers the adapter AD within the region R1 that is larger than the size of the adapter AD on the support plates 541 and 542. In this way, the adapter AD is placed on the support plates 541 and 542. The extending direction of the support plates 541 and 542 (the longitudinal direction of the adapter AD placed on the support plates 541 and 542 (the extending direction of the sides S3 and S4)) coincides with the X-direction. Hereafter, the posture of the adapter AD placed on the support plates 541 and 542 shown in FIG. 18 is referred to as the “reference posture.”

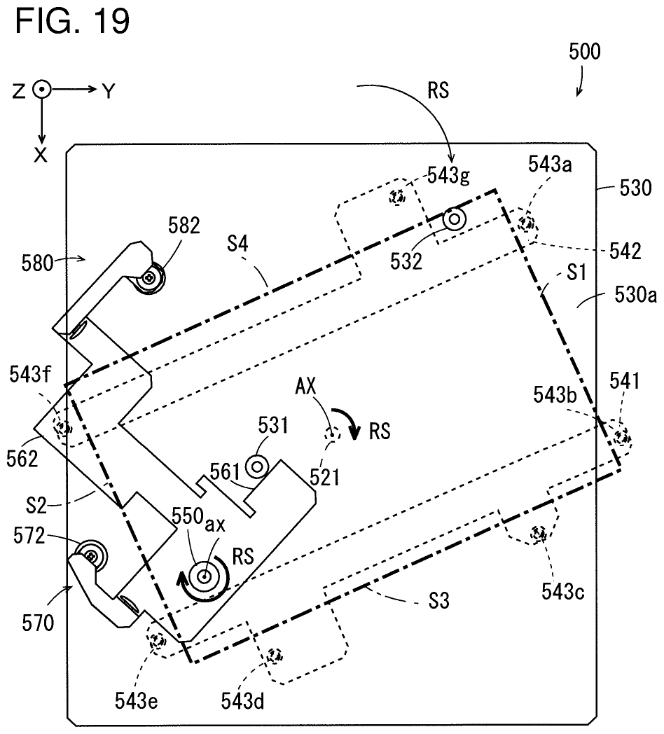

Here, an example will be described in which the first rotation shaft 521 is rotated to the right side (clockwise) about the first axis AX by the rotary drive unit 510. When the rotary drive unit 510 causes the first rotation shaft 521 to rotate to the right side RS (clockwise) centering on the first axis AX from the state shown in FIG. 18, the arm 560 and the support plates 541 and 542 rotate integrally with the first rotation shaft 521 via the above-described rotation plate 522 and the connection members 523 (both not illustrated). As shown in FIG. 19, when the first rotation shaft 521 rotates further to the right side RS (clockwise) about the first axis AX, the first contact portion 561 of the arm 560 and the first fixing portion 531 of the fixing plate 530 contact each other. In a state in which the first contact portion 561 and the first fixing portion 531 come into contact with each other, the further rotation of the first rotation shaft 521 to the right side RS (clockwise) exerts the rotation force to the right side RS (clockwise) on the arm 560.

In this case, the arm 560 rotates relative to the support plates 541 and 542 about the second axis ax of the second rotation shaft 550. In this example, the arm 560 rotates to the right side RS (clockwise) about the second axis ax with respect to the support plates 541 and 542, which rotate to the right side RS (clockwise) about the first axis ax.

As the first rotation shaft 521 further rotates to the right side RS (clockwise) about the first axis AX, the arm 560 further rotates to the right side RS (clockwise) about the second axis ax of the second rotation shaft 550. This causes the bearing 572 of the first pressing portion 570 to rotate (toward the Y-direction) toward the projections 543a and 543b facing each other across the adapter AD, which brings the bearing 572 and the side S2 of the adapter AD into contact with each other. At the same time, this causes the bearing 582 of the second pressing portion 580 to rotate (toward the X-direction) toward the projections 543c and 543d facing each other across the adapter AD, which brings the bearing 582 into contact with the fourth side S4 of the adapter AD.

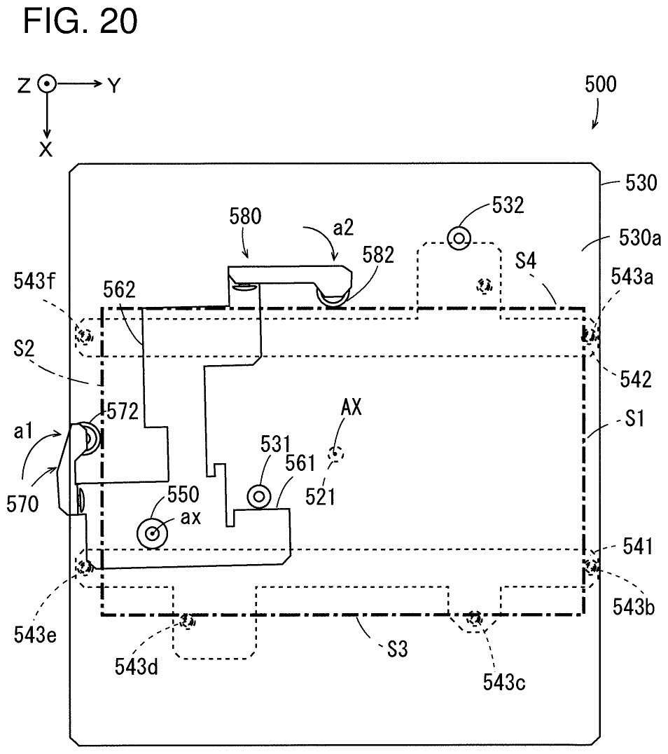

When the first rotation shaft 521 further rotates to the right side RS (clockwise) about the first axis AX, the adapter AD on the support plates 541 and 542 is rotated by 90 degrees clockwise from the reference posture, as shown in FIG. 20. Note that in the posture in which the adapter AD is rotated by 90 degrees clockwise from the reference posture, the extending direction of the support plates 541 and 542 (the longitudinal direction of the adapter AD placed on the support plates 541 and 542 (the extending direction of the sides S3 and S4)) and the Y-direction coincide.

In this case, the side S2 of the adapter AD is pressed by the bearing 572, and the side S4 of the adapter AD is pressed by the bearing 582. This causes the adapter AD to move in the direction (Y-direction) toward the projections 543a and 543b and in the direction (X-direction) toward the projections 543c and 543d, whereby the side S1 of the adapter AD comes into contact with the projections 543a and 543b, and the side S3 comes into contact with 543c and 543d.

The adapter AD placed on the support plates 541 and 542 is sandwiched between the bearing 572 and the projections 543a and 543b, and between the bearing 582 and the projections 543c and 543d. As a result, the adapter AD can be held on the support plates 541 and 542 with the side S1 of the adapter AD in contact with the projections 543a and 543b and the side S3 of the adapter AD in contact with the projections 543c and 543d. Hereafter, the state in which the adapter AD is held on the support plates 541 and 542 is referred to as the “fixed state.”

Further, the bearing 572 and the bearing 582 are connected to the arm 560 via the leaf spring 571 and the leaf spring 581, respectively. Therefore, the leaf springs 571 and 581 deform in the direction that the bearings 572 and 582 move outward by receiving the forces from the sides S2 and S4 that repel the pressing force. In this case, the forces of the leaf springs 571 and 581 to return to their flat shapes further press the bearing 572 against the side S2 of the adapter AD and the bearing 582 against the side S4 of the adapter AD. As a result, the pressing force of the bearing 572, 582 against the adapter AD can be increased. Thus, the adapter AD can be held more stably.

Next, an example will be described in which the first rotation shaft 521 is rotated to the left side (counterclockwise) about the first axis AX by the rotary drive unit 510 from the state in which the adapter AD is in the reference posture shown in FIG. 18.

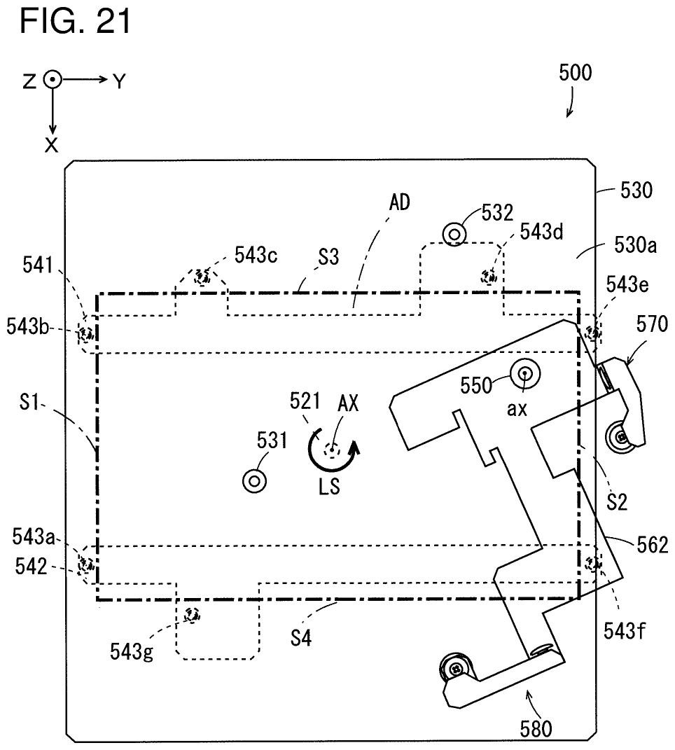

When the rotary drive unit 510 causes the first rotation shaft 521 to rotate to the left side LS (counterclockwise) about the first axis AX from the state shown in FIG. 18, the arm 560 and the support plates 541 and 542 rotate to the left side LS (counterclockwise) integrally with the first rotation shaft 521 via the connection member 520. When the first rotation shaft 521 further rotates to the left side (counterclockwise) about the first axis AX, the adapter AD on the support plates 541 and 542 is rotated by 90 degrees counterclockwise from the reference posture, as shown in FIG. 21. Note that in the posture in which the adapter AD is rotated by 90 degrees counterclockwise from the reference posture, the extending direction of the support plates 541 and 542 (the longitudinal direction of the adapter AD placed on the support plates 541 and 542 (the extending direction of the sides S3 and S4)) and the Y-direction coincide. In the posture in which the adapter AD on the support plates 541 and 542 is rotated by 90 degrees counterclockwise from the reference posture, the posture change device 500 is in the released state.

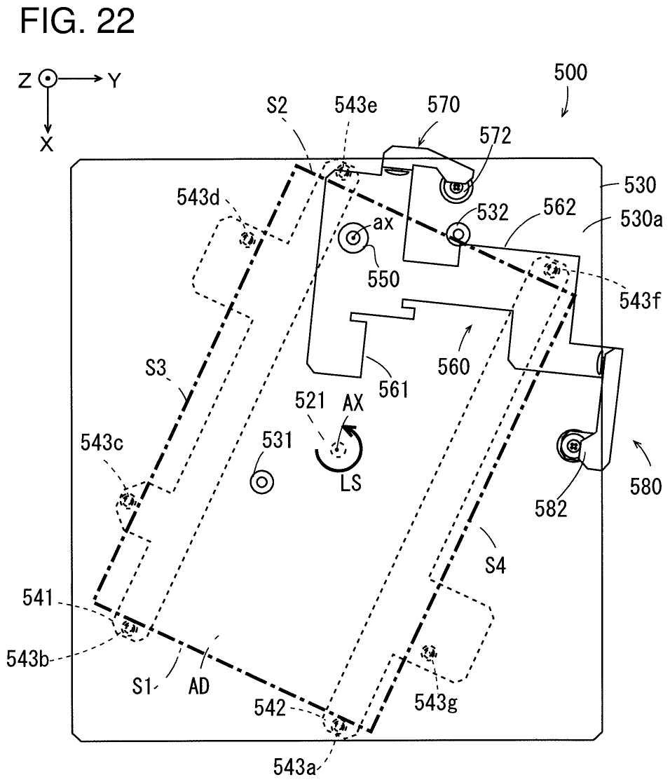

When the first rotation shaft 521 further rotates to the left side LS (counterclockwise) about the first axis AX, the second contact portion 562 of the arm 560 and the second fixing portion 532 of the fixing plate 530 come into contact with each other as shown in FIG. 22. When the second contact portion 562 and the second fixing portion 532 come into contact, the rotation of the first rotation shaft 521 further to the left side LS (counterclockwise) exerts a rotation force to the left side LS (counterclockwise) on the arm 560. Thereby, the arm 560 and the support plates 541 and 542 rotate relative to each other.

Specifically, when the first rotation shaft 521 further rotates to the left side LS (counterclockwise) about the first axis AX, the second contact portion 562 slides against the second fixing portion 532 while the second contact portion 562 is in contact with the second fixing portion 532. This causes the side S2 of the adapter AD to rotate toward the bearing 572 of the first pressing portion 570, which in turn causes the bearing 572 of the first pressing portion 570 to rotate toward the side S2 of the adapter AD. As a result, the bearing 572 and the side S2 of the adapter AD come into contact with each other. At the same time, the side S4 of the adapter AD rotates toward the bearing 582 of the second pressing portion 580, which causes the bearing 582 of the second pressing portion 580 to rotate toward the side S4 of the adapter AD. As a result, the bearing 572 and the side S4 of the adapter AD come into contact with each other.

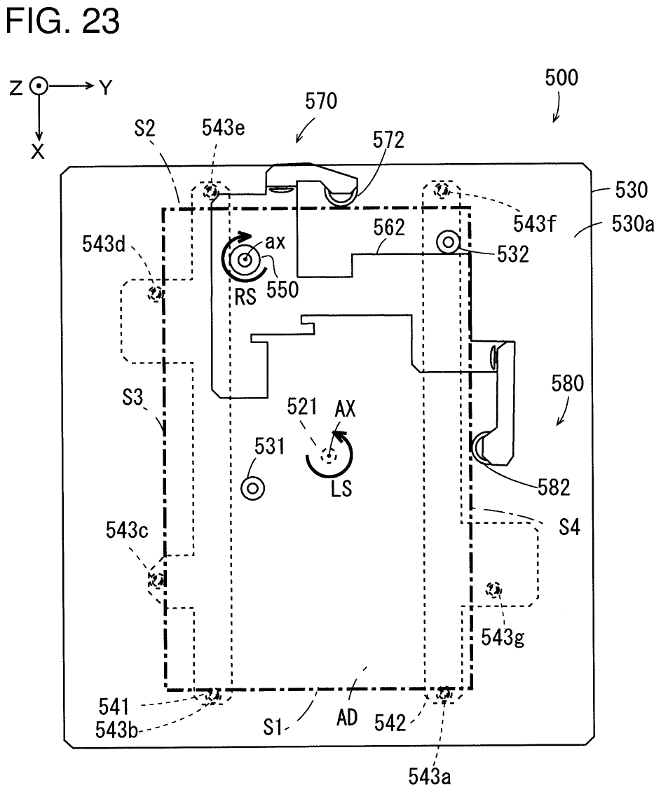

When the first rotation shaft 521 further rotates to the right side RS (counterclockwise) about the first axis AX, the adapter AD on the support plates 541 and 542 is rotated by 90 degrees to the left side (counterclockwise) from the reference posture, as shown in FIG. 23.

Note that in the posture in which the adapter AD is rotated by 90 degrees counterclockwise from the reference posture, the extending direction of the support plates 541 and 542 extend (the longitudinal direction of the adapter AD placed on the support plates 541 and 542 (the extending direction of the sides S3 and S4)) and the X-direction coincide. In this case, the side S2 of the adapter AD is pressed by the bearing 572, and the side S4 of the adapter AD is pressed by the bearing 582. The adapter AD moves in the direction (X-direction) toward the projections 543a and 543b and in the direction (direction opposite to the Y-direction) toward the projections 543c and 543d. This causes the side S1 of the adapter AD to come into contact with the projections 543a and 543b, and the side S3 to come into contact with the projections 543c and 543d.

As a result, the adapter AD placed on the support plates 541 and 542 is sandwiched between the bearing 572 and the projections 543a and 543b, and between the bearing 582 and the projections 543c and 543d. The adapter AD can be held on the support plates 541 and 542 with the side S1 of the adapter AD in contact with the projections 543a and 543b and the side S3 of the adapter AD in contact with the projections 543c and 543d. The actions and effects achieved by the leaf springs 571 and 581 in this case are the same as those described above.

In the posture change device 500 of this example, the adapter AD placed on the support plates 541 and 542 can be held only by driving the rotary drive unit 510. Further, in the posture change device 500 of this example, the projections 543a and 543b are provided at positions where they come into contact with the side S1 of the adapter AD, and the projections 543c and 543d are provided at positions where they come into contact with the side S3 of the adapter AD. With this, the adapter AD on the support plates 541 and 542 can be held at a desired position. As a result, the container can be held at a desired position in the support portion only by driving the rotary drive unit 510 without using a new drive source.

In this example of the posture change device 500, the adapter AD is in the released state in the reference posture, and the adapter AD is in the fixed state in the posture in which the adapter AD is rotated 90 degrees clockwise from the reference posture. The released state is maintained when the adapter AD is rotated by 90 degrees counterclockwise from the reference posture, and it becomes in a fixed state when the adapter AD is rotated by 180 degrees counterclockwise from the reference posture.

In other words, it is possible to switch between the released state and the fixed state when the longitudinal direction of the adapter AD is aligned with the X-direction. Further, it can be switched between the released state and the fixed state when the longitudinal of the adapter AD and the Y-direction coincide. Therefore, two postures can be selected for the adapter AD to be transferred by the transfer robot. Further, since it is possible to fix the container in two mutually orthogonal postures, it is possible to perform dispensing by the dispensing device 100 even if the container placed on the posture change device 500 is an adapter AD or the first well plate WP.

In the above-described example, an example is shown in which the arm 560 is provided with the first pressing portion 570 and the second pressing portion 580. However, it is sufficient that the arm 560 is provided with one of the first pressing portions 570 and the second pressing portions 580. In the case where the arm 560 is not provided with the second pressing portion 580 but is provided with the first pressing portion 570, the support plate 541 may not be provided with the projections 543c and 543d. In the case where the arm 560 is not provided with the first pressing portion 570 but is provided with the second pressing portion 580, it may be configured such that the support plate 541 is not provided with the projection 543b and the support plate 542 is not provided with the projection 543a.

In the above-described example, the posture change device 500 is used in place of the rotary drive unit 30 of the dispensing device 100, the connection member 31, and the second support portion 22. However, the posture change device 500 may be used in place of any or all of the plurality of first support portions 21 of the dispensing device 100.

### (5) Other Embodiments

### 5-1

In the above-described embodiment, the rotary drive unit 30 is provided to rotate the second support portion 22, but the present disclosure is not limited thereto. The rotary drive unit 30 may be provided on the dispensing head 10. This allows the dispensing head 10 to be rotated relative to the second well plate wp of the second support portion 22. Further, the rotary drive unit 30 may be provided on both the second support portion 22 and the dispensing head 10. In that case, both the second support portion 22 and the dispensing head 10 may be rotated.

### 5-2

In the above-described embodiment, the alignment direction of the plurality of tip attachments 12 of the dispensing head 10 coincides with the alignment direction of the plurality of wells WL of the first well plate WP supported by the first support portion 21. However, in the case where a rotary drive unit is provided to at least one of the dispensing head 10 and the first support portion 21, the alignment direction of the plurality of tip attachments 12 of the dispensing head 10 may be different from the alignment direction of the plurality of wells WL of the first well plate WP supported by the first support portion 21. In this case, by rotating one of the dispensing head 10 and the first support portion 21 with the rotary drive unit, the alignment direction of the plurality of tip attachments 12 of the dispensing head 10 can be aligned with the alignment direction of the plurality of wells WL of the first well plate WP supported by the first support portion 21.

### 5-3

In the above-described embodiment, the first pitch ΔI1 of the plurality of wells WL of the first well plate WP is set to two times the second pitch ΔI2 of the plurality of wells wl of the second well plate wp. However, the first pitch ΔI1 may be set to an integer multiple other than two times the second pitch ΔI2. Furthermore, as the first well plate WP, other well plates that differ from the above-described embodiment in the number and arrangement of wells WL may be used, and as the second well plate wp, and other well plates that differ from the above-described embodiment in the number and arrangement of wells may be used.

### 5-4

In the above-described embodiment, an example is shown in which the first to n^{th} first support portions 21 are fixed on the stage St, and the dispensing head 10 moves in the X- and Y-directions. However, it may be configured such that a moving mechanism for moving each of the first to n^{th} first support portions 21 in the X- and Y-directions is provided. In this case, it may not be configured such that the drive mechanism 10a of the dispensing head 10 moves the dispensing head 10 in the X- and Y-directions. Alternatively, the drive mechanism 10a may not be provided.

### 5-5

In the above-described embodiment, an example is described in which the dispensing device 100 is used for immunoprecipitation processing as preprocessing for analysis and measurement of a target polypeptide in a biological sample by MALDI-MS, but the present disclosure is not limited thereto. The dispensing device 100 may be used for other processing, such as preprocessing of cultured microorganism-derived samples for analysis and measurement by MALDI-MS, for example. In this case, the dispensing device 100 may be equipped with a centrifugal separation unit in addition to the configuration described in the above-described embodiment. An example of the flow when the dispensing device 100 is used for preprocessing of a sample derived from a cultured microorganism for analysis and measurement is as follows. First, a pellet including bacterial components is extracted after the steps of washing bacteria, extracting bacterial components, and centrifuging the bacteria are performed in the first well plate WP. Thereafter, the pellet including the extracted bacterial components is dispensed into a second well plate wp. Subsequent operations are the same as those in the above-described embodiment.

### 5-6

In the above-described embodiments, an example is described in which the analysis device is a MALDI-MS, but other analysis devices may be used.

### (6) Correspondence Relation Between Each Component Recited in Claims and Each Part of Embodiment

In the following, an example of correspondence between each component recited in claims and each element of the embodiment will be described. In the above-described embodiment, the correspondence is as follows. The first and second well plates WP and wp and the adapter AD are examples of the containers. The wells WL and wl are examples of wells. The first and second support portions 21 and 22 are examples of the support portions. The rotary drive units 30 and 510 are examples of the first drive units. The drive mechanism 10a is an example of the second drive unit. The well WL is an example of the first well. The first well plate WP is an example of the first and third containers. The well wl is an example of the second well. The second well plate wp is an example of the second container. The (n−1)^{th} first support portion 21 is an example of the third support portion. The projections 543a and 543b are examples of the first contact portions. The projections 543c and 543d are examples of the second contact portions. The leaf spring 571 is an example of the first leaf spring. The leaf spring 581 is an example of the second leaf spring. The bearing 572 is an example of the first bearing. The bearing 582 is the second bearing.

### (7) Aspects

It would be understood by those skilled in the art that the exemplary embodiments described above are specific examples of the following aspects.

### (Item 1)

A dispensing device according to one aspect of the present disclosure is a dispensing device capable of aspirating liquid from or dispensing liquid into each of a plurality of wells provided on a container, the plurality of wells being aligned linearly. The dispensing device includes:
a support portion configured to support the container;
a dispensing head having a plurality of tip attachments aligned linearly, the dispensing head being configured to aspirate and dispense a liquid from or into dispensing tips attached to the tip attachments; and
a first drive unit configured to rotate at least one of the dispensing head and the support portion relative to the other so that an alignment direction of the plurality of tip attachments coincides with an alignment direction of the plurality of wells.

In the dispensing device as recited in the above-described Item 1, even in a case where the alignment direction of the plurality of tip attachments of the dispensing head and the alignment direction of the plurality of wells of the container supported by the support portion are different, at least one of the dispensing head and the support portion is rotated by the first drive unit relative to the other. With this, it is possible to align the alignment direction of the plurality of tip attachments of the dispensing head with the alignment direction of the plurality of wells of the container supported by the support portions. Therefore, it is possible to aspirate or dispense the liquid with a simple configuration and dispense operation for various well plates with different alignment directions of the plurality of wells wl while suppressing the cost increase.

### (Item 2)

In the dispensing device as recited in the above-described Item 1, it may be configured such that
the container includes a first container having a plurality of first wells and a second container having a plurality of second wells,
the support portion includes a first support portion configured to support the first container so that the plurality of first wells is aligned in a first direction and a second support portion configured to support the second container so that the plurality of second wells is aligned in a second direction that intersects the first direction,
the first drive unit is configured to rotate the dispensing head relative to the first support portion or the second support portion or to rotate the first support portion or the second support portion relative to the dispensing head, and
the dispensing device further comprises a controller to control the dispensing head and the first drive unit such that the liquid is aspirated from two or more first wells of the first container into two or more dispensing tips of the dispensing head in a state in which the alignment direction of the plurality of tip attachments coincides with an alignment direction of the plurality of first wells, and then the aspirated liquid is dispensed into two or more second wells of the second container in a state in which the alignment direction of the plurality of tip attachments coincides with an alignment direction of the plurality of second wells.

According to the dispensing device described in the above-described Item 2, the first support portion, the second support portion or the dispensing head can be rotated. Thereby, it is possible to align the alignment direction of the plurality of tip attachment portions of the dispensing head with the alignment direction of the plurality of first wells of the first container supported by the first support portion, and align the alignment direction of the plurality of tip attachment portions of the dispensing head with the alignment direction of the plurality of second wells of the second container supported by the second support portion. Therefore, even in the case where the alignment direction of the plurality of wells in the first container and the alignment direction of the plurality of second wells in the second container are different, a liquid can be aspirated from each first well by the dispensing head, and the aspirated liquid can be easily dispensed into each second well in the second container by the dispensing head.

### (Item 3)

In the dispensing device as recited in the above-described Item 2, it may be configured such that it further includes:
a second drive unit configured to move the dispensing head in the first direction and the second direction relative to the first support portion and the second support portion or to move the first support portion and the second support portion in the first direction and the second direction relative to the dispensing head; and
a third support portion configured to support a third container having a plurality of third wells,
wherein the first container includes a plurality of first dispensing units, each first dispensing unit including a predetermined number of first wells,
wherein the second container includes a plurality of second dispensing units, each second dispensing unit including a predetermined number of second wells,
wherein the third container includes a plurality of third dispensing units, each third dispensing unit including a predetermined number of third wells, and
wherein the controller controls the dispensing head, the first drive unit, and the second drive unit such that a series of operations is performed consecutively, the series of operations including aspirating a liquid from a plurality of third wells of one third dispensing unit of the third container, dispensing a liquid into the plurality of first wells of one first dispensing unit, aspirating a liquid from the plurality of first wells of the one first dispensing unit, and dispensing a liquid into the plurality of second wells of one second dispensing unit in turn, and thereafter, the series of operations for the other third dispensing units, the other first dispensing units, and other dispensing units are performed consecutively

According to the dispensing device described in the above-described Item 3, it is possible to continuously move the liquid from each third well of one third dispensing unit of the third container to each second well of one second dispensing unit of the second container via each first well of one first dispensing unit of the first container. In this case, the liquid dispensed into each first well of one first dispensing unit is aspirated, and the aspirated liquid is dispensed into each second well of one second dispensing unit. After that, the liquid is dispensed into each first well of the other first dispensing unit. Therefore, the time during which the liquid is accommodated in each first well of one first dispensing unit becomes equal to the time during which the liquid is accommodated in each first dispensing unit of the other first dispensing unit. Thereby, even in the case where the liquid accommodated in the plurality of first wells changes with time, such as a volatile liquid, the difference in the processing results of the liquid accommodated in the plurality of first wells of the first container is suppressed.

### (Item 4)

In the dispensing device as recited in the above-described Item 3, it may be configured such that
the plurality of first wells of the first container includes at least H (“H” is an integer greater than or equal to 2) pieces of first wells aligned in at least one row at a first pitch,
the plurality of second wells of the second container include M pieces of second wells arranged in at least one row at a second pitch, where M is m times H (“m” is an integer greater than or equal to 2),
the first pitch is an integer multiple of the second pitch,
the M pieces of second wells of the second container are classified into m sets, each m set including H pieces of second wells, and
the controller controls the dispensing head, the first drive unit, and the second drive unit such that an aspirating operation to aspirate a liquid from the H pieces of first wells out of the plurality of first wells into H pieces of dispensing tips is performed, and a dispensing operation to dispense the aspirated liquid into one set of the H pieces of second wells.

According to the dispensing device as recited in the above-described Item 4, the liquid aspirated from H pieces of first wells of the first container can be dispensed into M (mxH) pieces of second wells.

### (Item 5)

In the dispensing device as recited in any one of the above-described Items 2 to 4, it may be configured such that
the first direction and the second direction are orthogonal to each other,
when the dispensing head aspirates the liquid from the first container, the alignment direction of the plurality of tip attachments coincides with the first direction, and
the controller controls the first drive unit to rotate one of the dispensing head and the second support portion by 90 degrees relative to the other between a time of aspirating the liquid from the first container by the dispensing head and a time of dispensing the liquid into the second container by the dispensing head.

According to the dispensing device as recited in the above-described Item 5, By rotating the dispensing head or the second support portion by 90 degrees, the liquid aspirated from the first container by the dispensing head can be easily dispensed into the second container.

### (Item 6)

In the dispensing device as recited in the above-described Item 1, it may be configured such that
the plurality of wells is arranged in a matrix of multiple rows and multiple columns, and
the plurality of tip attachments is arranged in a matrix of multiple rows and multiple columns.

According to the dispensing device as recited in the above-described Item 6, it is possible to aspirate or dispense a liquid to a larger number of wells in a single dispensing operation.

### (Item 7)

A dispensing method according to another aspect of the present disclosure is a dispensing method of performing dispensing using a dispensing head having a plurality of tip attachments aligned linearly. The method includes:
a step of supporting a container by a support portion, the container having a plurality of wells aligned linearly;
a step of rotating at least one of the dispensing head and the support portion relative to the other so that an alignment direction of the plurality of tip attachments coincides with an alignment direction of the plurality of wells; and
a step of aspirating a liquid from the plurality of wells of the container into dispensing tips attached to the plurality of respective tip attachments or dispensing the liquid from the dispensing tips attached to the plurality of respective tip attachments into the plurality of wells of the container, in a state in which the alignment direction of the plurality of tip attachments coincides with the alignment direction of the plurality of wells.

According to the dispensing method as recited in the above-described Item 7, even in the case where the alignment direction of the plurality of tip attachments of the dispensing head is different from the alignment direction of the plurality of wells of the container supported by the support portions. At least one of the dispensing head and the support portion is rotated relative to the other by the first drive unit. With it, it is possible to align the alignment direction of the plurality of tip attachments of the dispensing head with the alignment direction of the plurality of wells of the container supported by the support portions. Therefore, it is possible to aspirate or dispense the liquid with a simple configuration and dispense operation for various well plates with different alignment directions of the plurality of wells wl while suppressing the cost increase.

### (Item 8)

In the dispensing device as recited in the above-described Item 1, it may be configured such that
the first drive unit rotates the support portion about a first rotation shaft relative to the dispensing head,
the dispensing device further comprises:
a second rotation shaft extending parallel to the first rotation shaft, the second rotation shaft being configured to rotate integrally with the support portion;
an arm attached to the second rotation shaft so as to be rotatable about the second rotation shaft, the arm having a first portion and a first pressing portion;
a first fixing portion; and
a first contact portion provided on the support portion so as to come into contact with a first side of the container supported by the support portion,
when the first fixing portion comes into contact with the first portion of the arm that rotates in one direction together with the support portion, the arm rotates relative to the support portion about the second rotation shaft, and
the first pressing portion presses the second side of the container facing the first side of the container supported by the support portion in a direction toward the first contact portion in accordance with a relative rotation of the arm relative to the support portion at a position facing the first contact portion across the container supported by the support portion to bring the first side of the container into contact with the first contact portion.

According to the dispensing device as recited in the above-described Item 8, the support portion supporting the container and the arm rotate in one direction about the first rotation shaft by the first drive unit. When the support portion and the arm are further rotated, the first portion of the arm and the first fixing portion come into contact with each other. Further, the rotation force in one direction about the first rotation shaft causes the arm and the support portion to rotate relative to each other about the second rotation shaft. As a result, the second side of the container supported by the support portion is pressed by the first pressing portion, which brings the first side of the container into contact with the first contact portion. This allows the container to be held in the region between the first pressing portion and the first contact portion, so that the container can be held in the region between the first pressing portion and the first contact portion. As a result, the container can be held in a desired position in the support portion only by driving the rotary drive unit without using a new drive source.

### (Item 9)

In the dispensing device as recited in the above-described Item 8, it may be configured such that
the arm further includes a second portion,
the dispensing device further comprises a second fixing portion,
when the second fixing portion comes into contact with the second portion of the arm that rotates in the other direction opposite to the one direction together with the support portion, the arm rotates relative to the support portion about the second rotation shaft, and
the first pressing portion presses the second side of the container supported by the support portion in a direction toward the first contact portion in accordance with a relative rotation of the arm relative to the support portion at a position facing the first contact portion across the container supported by the support portion to bring the first side of the container into contact with the first contact portion.

According to the dispensing device as recited in the above-describe Item 9, the support portion supporting the container and the arm rotate in the other direction about the first rotation shaft by the first drive unit. When the support portion and the arm are further rotated, the second portion of the arm and the second fixing portion come into contact with each other. Further, the rotation force in the other direction about the first rotation shaft causes the arm and the support portion to rotate relative to each other about the second rotation shaft. As a result, the container supported by the support portion comes into contact with the first contact portion while being pressed by the first pressing portion. This causes the container to be sandwiched between the first pressing portion and the first contact portion in the support portion. As a result, it is possible to hold the container in a desired position in the support portion with the support portion rotated to two different angles from each other.

### (Item 10)

In the dispensing device as recited in the above-described Item 9, it may be configured such that
the second fixing portion is provided at a predetermined position so that the first pressing portion does not press the second side of the container when the support portion is in a reference posture and the first pressing portion presses the second side of the container in a direction toward the first contact portion in a posture in which the support portion is rotated by 180 degrees in the other direction from the reference posture to bring the first side of the container into contact with the first contact portion.

According to the dispensing device as recited in the above-described Item 10, it is possible to shift the container supported by the support portion between a state of being held in the same posture and a state of not being held in the same posture.

### (Item 11)

In the dispensing device as recited in the above-described Item 10, it may be configured such that
the first fixing portion is provided at a predetermined position different from the position where the second fixing portion is provided so that the first pressing portion does not press the second side of the container in a posture in which the support portion is rotated by 90 degrees in the other direction from the standard posture, and the first pressing portion presses the second side of the container in a direction toward the first contact portion in a posture in which the support portion is rotated by 90 degrees in one direction from the reference posture to bring the first side of the container come into contact with the first contact portion.

According to the dispensing device as recited in the above-described Item 11, in the case where the alignment direction of the plurality of tip attachment portions of the dispensing head and the alignment direction of the plurality of wells of the container supported by the support portion differ by 90 degrees, it is possible to hold the container in the state in which the alignment direction of the plurality of tip attachment portions of the dispensing head and the alignment direction of the plurality of wells of the container supported by the support portion coincide. Furthermore, even in the case where the alignment direction of the plurality of tip attachments of the dispensing head and the alignment direction of the plurality of wells of the container supported by the support portions are the same, it is possible to hold the container in a state in which the alignment direction of the plurality of tip attachments of the dispensing head and the alignment direction of the plurality of wells of the container supported by the support portions are aligned. Further, for example, in a state in which the longitudinal direction of the container is vertical, the container can be set to a state in which it is held and not held, and in a state in which the longitudinal direction of the container is horizontal, the container can be set to a state in which it is held and not held. Therefore, when transferring a container with a transfer robot, the transfer robot can transfer the container without considering the posture of the container.

### (Item 12)

In the dispensing device as recited in any one of the above-described Items 8 to 11, it may be configured such that
the first pressing portion includes a first bearing that comes into contact with the second side of the container supported by the support portion.

According to the dispensing device as recited in the above-described Item 12, when the container supported by the support portion comes into contact with the first bearing, the first bearing can rotate due to the contact between the second side of the container and the first bearing. With this, the generation of friction between the second side of the container and the first bearing is suppressed. This prevents the misalignment of the container with the support portion due to friction between the second side of the container and the first bearing.

### (Item 13)

In the dispensing device as recited in the above-described Item 12, it may be configured such that
the first pressing portion further includes a flat-shaped first leaf spring that connects the first bearing to the arm.

According to the dispensing device as recited in the above-described Item 13, the first leaf spring is deformed according to the force of contact between the container supported by the support portion and the first bearing in a state in which the first side of the container and the first contact portion are in contact with each other. In this case, the force of the first leaf spring to return to the flat plate shape enables further pressing of the container supported by the support portion. This allows the container to be held more securely.

### (Item 14)

In the dispensing device as recited in any one of the above-described Items 8 to 13, it may be configured such that
the arm further includes a second pressing portion,
the dispensing device further comprises,
a second contact portion provided on the support portion so as to come into contact with a third side of the container supported by the support portion,
when the first fixing portion comes into contact with the first portion of the arm that rotates in the one direction together with the support portion, the arm rotates relative to the support portion about the second rotation shaft, and
the second pressing portion presses the fourth side of the container facing the third side of the container supported by the support portion in a direction toward the second contact portion in accordance with a relative rotation of the arm relative to the support portion at a position facing the second contact portion across the container supported by the support portion to bring the third side of the container into contact with the second contact portion.

According to the dispensing device as recited in the above-described Item 14, the container supported by the support portion is pressed in the direction toward the second contact portion by the second pressing portion while being pressed in the direction toward the first contact portion by the first pressing portion. In this case, the container is pressed from two different directions to be brought into contact with the first contact portion and the second contact portion. As a result, the container is held between the first pressing portion and the first contact portion while being held between the second pressing portion and the second contact portion. Therefore, the container is held within the region formed by the first pressing portion and the second pressing portion, and therefore, the container can be held in a more precise position.

### (Item 15)

In the dispensing device as recited in the above-described item 14, it may be configured such that
the second pressing portion includes a second bearing that comes into contact with the fourth side of the container supported by the support portion.

According to the dispensing device as recited in the above-described Item 15, when the container supported by the support portion comes into contact with the second bearing, the second bearing can rotate due to the contact between the fourth side of the container and the second bearing. With this, the generation of friction between the fourth side of the container and the second bearing is suppressed. This suppresses the misalignment of the container with the support portion due to friction between the fourth side of the container and the second bearing.

### (Item 16)

In the dispensing device as recited in the above-described Item 15, it may be configured such that
the second pressing portion further includes a flat-shaped second leaf spring that connects the second bearing to the arm.

According to the dispensing device as recited in the above-described Item 16, the second leaf spring is deformed according to the force of contact between the container supported by the support portion and the second bearing in a state in which the third side of the container and the second contact portion are in contact with each other. In this case, the force of the second leaf spring to return to the flat plate shape enables further pressing of the container supported by the support portion. This allows the container to be held more securely.

### (Item 17)

In the dispensing method as recited in the above-described Item 7, it may be configured such that
the step of rotating at least one of the dispensing head and the support portion causes the support portion to rotate about the first rotation shaft relative to the dispensing head,
the control method further comprises:
a step of rotating the arm relative to the support portion about the second rotation shaft when the first fixing portion comes into contact with a first portion of the arm that rotates in one direction together with the support portion; and
a step of bringing the first side of the container into contact with the first contact portion by pressing the second side of the container supported by the support portion facing the first side of the container in a direction toward the first contact portion in accordance with a relative rotation of the arm relative to the support portion at a position facing the first contact portion across the container supported by the support portion.

According to the dispensing method as recited in the above-described Item 17, the second side of the container supported by the support portion is pressed by the first pressing portion, which brings the first side of the container into contact with the first contact portion. This allows the container to be held in the region between the first pressing portion and the first contact portion, so that the container can be held in the region between the first pressing portion and the first contact portion. As a result, the container can be held in a desired position in the support portion only by driving the first rotary drive unit without using a new drive source.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

1. A dispensing device capable of aspirating or dispensing a liquid from or into each of a plurality of wells provided on a container, the plurality of wells being aligned linearly, the dispensing device comprising:
a support portion configured to support the container;
a dispensing head having a plurality of tip attachments aligned linearly, the dispensing head being configured to aspirate and dispense a liquid from or into dispensing tips attached to the tip attachments; and
a first drive unit configured to rotate at least one of the dispensing head and the support portion relative to the other so that an alignment direction of the plurality of tip attachments coincides with an alignment direction of the plurality of wells.

2. The dispensing device as recited in claim 1,
wherein the container includes a first container having a plurality of first wells and a second container having a plurality of second wells,
wherein the support portion includes a first support portion configured to support the first container so that the plurality of first wells is aligned in a first direction and a second support portion configured to support the second container so that the plurality of second wells is aligned in a second direction that intersects the first direction,
wherein the first drive unit is configured to rotate the dispensing head relative to the first support portion or the second support portion or to rotate the first support portion or the second support portion relative to the dispensing head, and
wherein the dispensing device further comprises a controller to control the dispensing head and the first drive unit such that the liquid is aspirated from two or more first wells of the first container into two or more dispensing tips of the dispensing head in a state in which the alignment direction of the plurality of tip attachments coincides with an alignment direction of the plurality of first wells, and then the aspirated liquid is dispensed into two or more second wells of the second container in a state in which the alignment direction of the plurality of tip attachments coincides with an alignment direction of the plurality of second wells.

3. The dispensing device as recited in claim 2, further comprising:
a second drive unit configured to move the dispensing head in the first direction and the second direction relative to the first support portion and the second support portion or to move the first support portion and the second support portion in the first direction and the second direction relative to the dispensing head; and
a third support portion configured to support a third container having a plurality of third wells,
wherein the first container includes a plurality of first dispensing units, each first dispensing unit including a predetermined number of first wells,
wherein the second container includes a plurality of second dispensing units, each second dispensing unit including a predetermined number of second wells,
wherein the third container includes a plurality of third dispensing units, each third dispensing unit including a predetermined number of third wells, and
wherein the controller controls the dispensing head, the first drive unit, and the second drive unit such that a series of operations is performed consecutively, the series of operations including aspirating a liquid from a plurality of third wells of one third dispensing unit of the third container, dispensing a liquid into the plurality of first wells of one first dispensing unit, aspirating a liquid from the plurality of first wells of the one first dispensing unit, and dispensing a liquid into the plurality of second wells of one second dispensing unit in turn, and thereafter, the series of operations for the other third dispensing units, the other first dispensing units, and other dispensing units are performed consecutively.

4. The dispensing device as recited in claim 3,
wherein the plurality of first wells of the first container includes at least H (“H” is an integer greater than or equal to 2) pieces of first wells aligned in at least one row at a first pitch,
wherein the plurality of second wells of the second container include M pieces of second wells arranged in at least one row at a second pitch, where M is m times H (“m” is an integer greater than or equal to 2),
wherein the first pitch is an integer multiple of the second pitch,
wherein the M pieces of second wells of the second container are classified into m sets, each m set including H pieces of second wells, and
wherein the controller controls the dispensing head, the first drive unit, and the second drive unit such that an aspirating operation to aspirate a liquid from the H pieces of first wells out of the plurality of first wells into H pieces of dispensing tips is performed, and a dispensing operation to dispense the aspirated liquid into one set of the H pieces of second wells.

5. The dispensing device as recited in claim 2,
wherein the first direction and the second direction are orthogonal to each other,
wherein when the dispensing head aspirates the liquid from the first container, the alignment direction of the plurality of tip attachments coincides with the first direction, and
wherein the controller controls the first drive unit to rotate one of the dispensing head and the second support portion by 90 degrees relative to the other between a time of aspirating the liquid from the first container by the dispensing head and a time of dispensing the liquid into the second container by the dispensing head.

6. The dispensing device as recited in claim 1,
wherein the plurality of wells is arranged in a matrix of multiple rows and multiple columns, and
wherein the plurality of tip attachments is arranged in a matrix of multiple rows and multiple columns.

7. A dispensing method of performing dispensing using a dispensing head having a plurality of tip attachments aligned linearly, the method comprising:
a step of supporting a container by a support portion, the container having a plurality of wells aligned linearly;
a step of rotating at least one of the dispensing head and the support portion relative to the other so that an alignment direction of the plurality of tip attachments coincides with an alignment direction of the plurality of wells; and
a step of aspirating a liquid from the plurality of wells of the container into dispensing tips attached to the plurality of respective tip attachments or dispensing the liquid from the dispensing tips attached to the plurality of respective tip attachments into the plurality of wells of the container, in a state in which the alignment direction of the plurality of tip attachments coincides with the alignment direction of the plurality of wells.

8. The dispensing device as recited in claim 1,
wherein the first drive unit rotates the support portion about a first rotation shaft relative to the dispensing head,
wherein the dispensing device further comprises:
a second rotation shaft extending parallel to the first rotation shaft, the second rotation shaft being configured to rotate integrally with the support portion;
an arm attached to the second rotation shaft so as to be rotatable about the second rotation shaft, the arm having a first portion and a first pressing portion;
a first fixing portion; and
a first contact portion provided on the support portion so as to come into contact with a first side of the container supported by the support portion,
wherein when the first fixing portion comes into contact with the first portion of the arm that rotates in one direction together with the support portion, the arm rotates relative to the support portion about the second rotation shaft, and
wherein the first pressing portion presses the second side of the container facing the first side of the container supported by the support portion in a direction toward the first contact portion in accordance with a relative rotation of the arm relative to the support portion at a position facing the first contact portion across the container supported by the support portion to bring the first side of the container into contact with the first contact portion.

9. The dispensing device as recited in claim 8,
wherein the arm further includes a second portion,
wherein the dispensing device further comprises a second fixing portion,
wherein when the second fixing portion comes into contact with the second portion of the arm that rotates in the other direction opposite to the one direction together with the support portion, the arm rotates relative to the support portion about the second rotation shaft, and
wherein the first pressing portion presses the second side of the container supported by the support portion in a direction toward the first contact portion in accordance with a relative rotation of the arm relative to the support portion at a position facing the first contact portion across the container supported by the support portion to bring the first side of the container into contact with the first contact portion.

10. The dispensing device as recited in claim 9,
wherein the second fixing portion is provided at a predetermined position so that the first pressing portion does not press the second side of the container when the support portion is in a reference posture and the first pressing portion presses the second side of the container in a direction toward the first contact portion in a posture in which the support portion is rotated by 180 degrees in the other direction from the reference posture to bring the first side of the container into contact with the first contact portion.

11. The dispensing device as recited in claim 10,
wherein the first fixing portion is provided at a predetermined position different from the position where the second fixing portion is provided so that the first pressing portion does not press the second side of the container in a posture in which the support portion is rotated by 90 degrees in the other direction from the standard posture, and the first pressing portion presses the second side of the container in a direction toward the first contact portion in a posture in which the support portion is rotated by 90 degrees in one direction from the reference posture to bring the first side of the container come into contact with the first contact portion.

12. The dispensing device as recited in claim 8,
wherein the first pressing portion includes a first bearing that comes into contact with the second side of the container supported by the support portion.

13. The dispensing device as recited in claim 12,
wherein the first pressing portion further includes a flat-shaped first leaf spring that connects the first bearing to the arm.

14. The dispensing device as recited in claim 8,
wherein the arm further includes a second pressing portion,
wherein the dispensing device further comprises,
a second contact portion provided on the support portion so as to come into contact with a third side of the container supported by the support portion,
wherein when the first fixing portion comes into contact with the first portion of the arm that rotates in the one direction together with the support portion, the arm rotates relative to the support portion about the second rotation shaft, and
wherein the second pressing portion presses the fourth side of the container facing the third side of the container supported by the support portion in a direction toward the second contact portion in accordance with a relative rotation of the arm relative to the support portion at a position facing the second contact portion across the container supported by the support portion to bring the third side of the container into contact with the second contact portion.

15. The dispensing device as recited in claim 14,
wherein the second pressing portion includes a second bearing that comes into contact with the fourth side of the container supported by the support portion.

16. The dispensing device as recited in claim 15,
wherein the second pressing portion further includes a flat-shaped second leaf spring that connects the second bearing to the arm.

17. The dispensing method as recited in claim 7,
wherein the step of rotating at least one of the dispensing head and the support portion causes the support portion to rotate about the first rotation shaft relative to the dispensing head,
wherein the control method further comprises:
a step of rotating the arm relative to the support portion about the second rotation shaft when the first fixing portion comes into contact with a first portion of the arm that rotates in one direction together with the support portion; and
a step of bringing the first side of the container into contact with the first contact portion by pressing the second side of the container supported by the support portion facing the first side of the container in a direction toward the first contact portion in accordance with a relative rotation of the arm relative to the support portion at a position facing the first contact portion across the container supported by the support portion.
